(19) United States
(12) Patent Application Publication
(10) Pub. No.: US 2025/0212079 A1
(43) Pub. Date: Jun. 26, 2025

(54) SENSING HANDOVER IN ISAC SYSTEMS

(71) Applicant: QUALCOMM Incorporated, San Diego, CA (US)

(72) Inventors: Min HUANG, Beijing (CN); Jing DAI, Beijing (CN); Peng CHENG, Beijing (CN); Mingxi YIN, Beijing (CN); Chao WEI, Beijing (CN); Yin HUANG, Beijing (CN); Hao XU, Beijing (CN)

(21) Appl. No.: 18/850,537

(22) PCT Filed: May 30, 2022
(86) PCT No.: PCT/CN2022/095877

§ 371 Date: Sep. 24, 2024

(51) Int. Cl. H04W 36/30; G01S 7/00; G01S 13/00; G01S 13/86; H04W 36/32

(52) U.S. Cl. CPC H04W 36/30; G01S 7/006; G01S 13/003; G01S 13/86; H04W 36/322

(57) ABSTRACT

Aspects presented herein relate to methods and devices for wireless communication including an apparatus, e.g., a UE or base station. The apparatus may detect whether a first sensing RSRP is less than a first threshold, the first sensing RSRP being associated with at least one sensing signal. The apparatus may also identify, upon detecting whether the first sensing RSRP is less than the first threshold, at least one second wireless device of a set of candidate second wireless devices, wherein the at least one second wireless device is identified based on a position of a target object. Further, the apparatus may transmit a sensing switch request message for the at least one second wireless device. The apparatus may also receive, based on the sensing switch request message, a sensing switch request ACK or a sensing switch request NACK from the at least one second wireless device.

### TECHNICAL FIELD

The present disclosure relates generally to communication systems, and more particularly, to sensing handover in wireless communication systems.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be an apparatus for wireless communication at a first wireless device. The apparatus may transmit or receive at least one sensing signal, where a first sensing reference signal received power (RSRP) is detected based on the transmitted at least one sensing signal or the received at least one sensing signal. The apparatus may also detect whether a first sensing RSRP is less than a first threshold, the first sensing RSRP being associated with at least one sensing signal. Further, the apparatus may identify, upon detecting whether the first sensing RSRP is less than the first threshold, at least one second wireless device of a set of candidate second wireless devices, where the at least one second wireless device is identified based on a position of a target object. The apparatus may also transmit a sensing switch request message for the at least one second wireless device. The apparatus may also transmit, based on the sensing switch request message, a sensing signal or a sensing signal configuration for the at least one second wireless device. Moreover, the apparatus may receive, based on the sensing switch request message, a sensing switch request acknowledgement (ACK) or a sensing switch request negative ACK (NACK) from the at least one second wireless device. The apparatus may also receive, based on the sensing switch request ACK or the sensing switch request NACK, a sensing report from the at least one second wireless device.

In an aspect of the disclosure, a method, a computer-readable medium, and an apparatus are provided. The apparatus may be an apparatus for wireless communication at a second wireless device. The apparatus may receive a sensing switch request message from a first wireless device, the sensing switch request message being based on whether a first sensing reference signal received power (RSRP) is less than a first threshold. The apparatus may also select a target sensing beam from a set of candidate target sensing beams based on a position of a target object associated with the second wireless device. Additionally, the apparatus may transmit or receive the at least one sensing signal, where the second sensing RSRP is detected based on the transmitted at least one sensing signal or the received at least one sensing signal. The apparatus may also detect whether a second sensing RSRP is greater than a second threshold, where the second sensing RSRP is associated with at least one sensing signal. The apparatus may also receive, based on detecting whether the second sensing RSRP is greater than the second threshold, a sensing signal or a sensing signal configuration from the first wireless device. Further, the apparatus may transmit, upon detecting whether the second sensing RSRP is greater than the second threshold, a sensing switch request acknowledgement (ACK) or a sensing switch request negative ACK (NACK) for the first wireless device. The apparatus may also transmit, based on the sensing switch request ACK or the sensing switch request NACK, a sensing report for the first wireless device.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of a wireless communication system.

FIG. 6A is a diagram illustrating an example of a wireless communication system utilizing monostatic sensing.

FIG. 6B is a diagram illustrating an example of a wireless communication system utilizing bi-static sensing or multi-static sensing.

FIG. 7 is a diagram illustrating an example of a wireless communication system.

FIG. 8 is a diagram illustrating an example of a wireless communication system.

FIG. 9 is a diagram illustrating an example of a communication flow for a wireless communication system.

FIG. 10 is a diagram illustrating an example of a wireless communication system.

FIG. 11 is a diagram illustrating an example of a communication flow for a wireless communication system.

FIG. 12 is a diagram illustrating an example of a wireless communication system.

FIG. 13 is a diagram illustrating an example of a communication flow for a wireless communication system.

FIG. 14 is a communication flow diagram illustrating example communications between first wireless device and a second wireless device.

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a diagram illustrating an example of a hardware implementation for an example apparatus and/or network entity.

FIG. 20 is a diagram illustrating an example of a hardware implementation for an example network entity.

### DETAILED DESCRIPTION

Some aspects of wireless communication may utilize object sensing. Certain types of object sensing may utilize radar sensing, which may be specified as monostatic sensing and bi-static/multi-static sensing. For example, object sensing or radar sensing may be utilized when sensing certain types of objects (e.g., unmanned aerial vehicles (UAVs)). In object or radar sensing, because of the irregular shape of target objects, reflected signals may be unevenly distributed in all directions. In order to increase the possibility of receiving the reflected sensing signal, some types of UEs (e.g., legacy UEs or sensing-dedicated UEs) may be involved in receiving the reflected signals. This type of object sensing is referred to as UE-assisted sensing, where the UE is referred to as a “sensing UE.” This type of object sensing may also be utilized to sense of other kinds of objects (e.g., planes, vehicles, ships, humans, animals, or any object). As indicated above, certain types of wireless communication may utilize UAV management (i.e., managing UAVs or other wireless objects to assist with sensing). There are a number of expected benefits of UAV management, such as a lowered deployment cost for existing physical sites for sensing or a reduced hardware cost for shared RF/baseband hardware with a base station (BS). Some types of UAV management may utilize wide area airspace management, which may fit for cooperative sensing and target tracking in wireless systems. Aspects of object sensing may include monostatic sensing and bi-static/multi-static sensing. In monostatic sensing, one radar/sensor both transmits and receives the sensing signal. In bi-static sensing or multi-static sensing, one radar/sensor transmits the sensing signal, and another radar/sensor receives the sensing signal that is reflected by a target object (e.g., a UAV). One issue of using a communication network to sense a UAV (or other target object) is the short coverage distance when sensing with a single base station or UE. This is because the base station or UE may not transmit a large-bandwidth signal with the same high Tx power as traditional radar. For example, the bandwidth for a base station or UE may be at most tens of MHz, but bandwidth for traditional radar may be several GHz. That is, the Tx power of a base station or UE is lower than traditional radar considering the radiation safety to humans. Therefore, the coverage of one base station or UE may be less than 1 km, but a traditional UAV-monitoring radar's coverage may be tens or hundreds of km. Aspects of the present disclosure may utilize multi-cell sensing (e.g., sensing with multiple cells), such as to support wide-area coverage of UAV monitoring. In some instances, aspects presented herein may utilize continuous sensing that relies on the consistent cooperation of multiple base stations or UEs in adjacent cells. Aspects of the present disclosure may also utilize schemes for a sensing handover (e.g., sensing UAVs that cross a cell border) in an integrated sensing and communication (ISAC) system. Additionally, aspects of the present disclosure may utilize sensing handover schemes for different use cases, such as different types of sensing node switching. For instance, aspects of the present disclosure may utilize monostatic sensing node switching, bi-static sensing node switching (e.g., bi-static sensing receiver switching or bi-static sensing transmitter switching), or multi-static sensing node switching.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

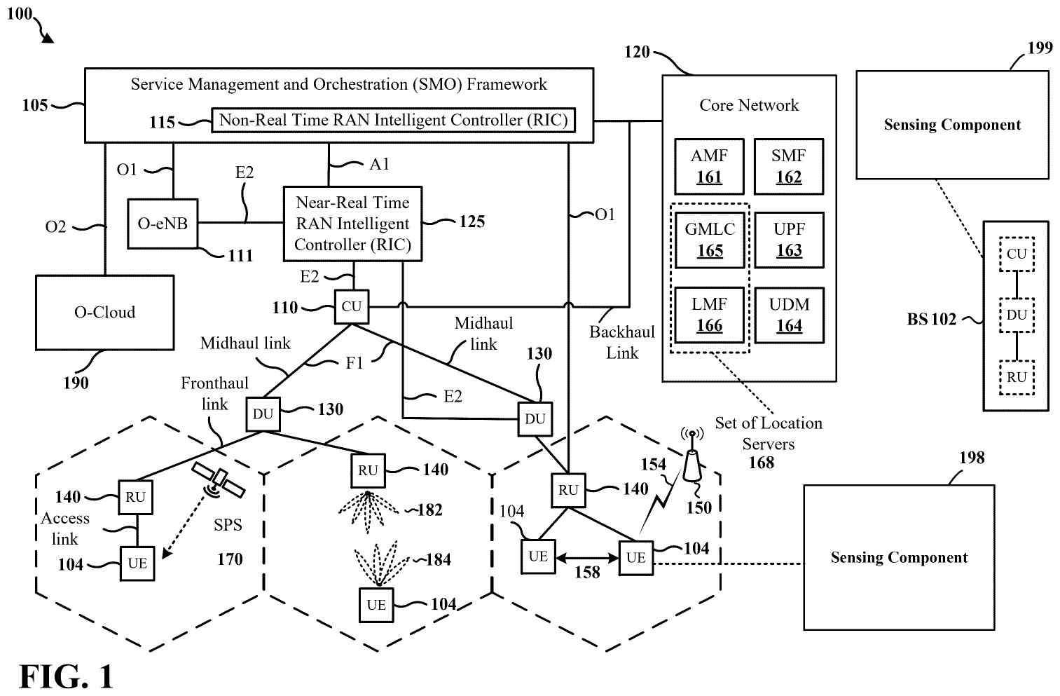

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a sensing component 198 that may be configured to transmit or receive at least one sensing signal, where a first sensing reference signal received power (RSRP) is detected based on the transmitted at least one sensing signal or the received at least one sensing signal. Sensing component 198 may also be configured to detect whether a first sensing RSRP is less than a first threshold, the first sensing RSRP being associated with at least one sensing signal. Sensing component 198 may also be configured to identify, upon detecting whether the first sensing RSRP is less than the first threshold, at least one second wireless device of a set of candidate second wireless devices, where the at least one second wireless device is identified based on a position of a target object. Sensing component 198 may also be configured to transmit a sensing switch request message for the at least one second wireless device. Sensing component 198 may also be configured to transmit, based on the sensing switch request message, a sensing signal or a sensing signal configuration for the at least one second wireless device. Sensing component 198 may also be configured to receive, based on the sensing switch request message, a sensing switch request acknowledgement (ACK) or a sensing switch request negative ACK (NACK) from the at least one second wireless device. Sensing component 198 may also be configured to receive, based on the sensing switch request ACK or the sensing switch request NACK, a sensing report from the at least one second wireless device.

In certain aspects, the base station 102 may include a sensing component 199 that may be configured to receive a sensing switch request message from a first wireless device, the sensing switch request message being based on whether a first sensing reference signal received power (RSRP) is less than a first threshold. Sensing component 199 may also be configured to select a target sensing beam from a set of candidate target sensing beams based on a position of a target object associated with the second wireless device. Sensing component 199 may also be configured to transmit or receive the at least one sensing signal, where the second sensing RSRP is detected based on the transmitted at least one sensing signal or the received at least one sensing signal. Sensing component 199 may also be configured to detect whether a second sensing RSRP is greater than a second threshold, where the second sensing RSRP is associated with at least one sensing signal. Sensing component 199 may also be configured to receive, based on detecting whether the second sensing RSRP is greater than the second threshold, a sensing signal or a sensing signal configuration from the first wireless device. Sensing component 199 may also be configured to transmit, upon detecting whether the second sensing RSRP is greater than the second threshold, a sensing switch request acknowledgement (ACK) or a sensing switch request negative ACK (NACK) for the first wireless device. Sensing component 199 may also be configured to transmit, based on the sensing switch request ACK or the sensing switch request NACK, a sensing report for the first wireless device. Although the following description may be focused on 5G NR, the concepts described herein may be applicable to other similar areas, such as LTE, LTE-A, CDMA, GSM, and other wireless technologies.

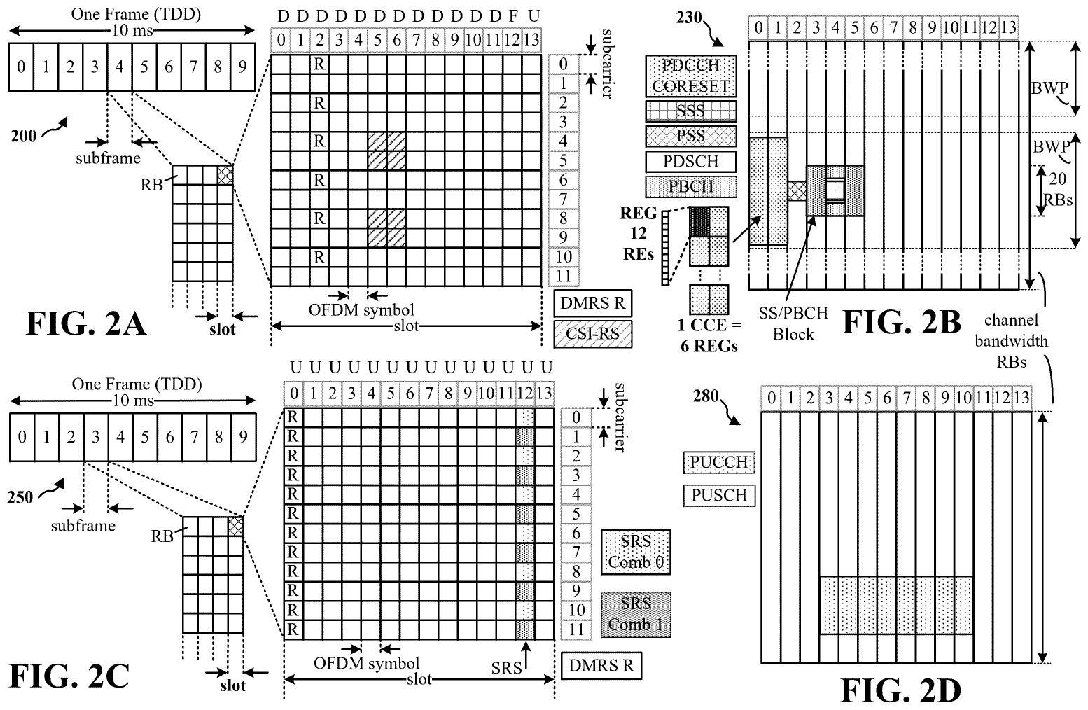

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

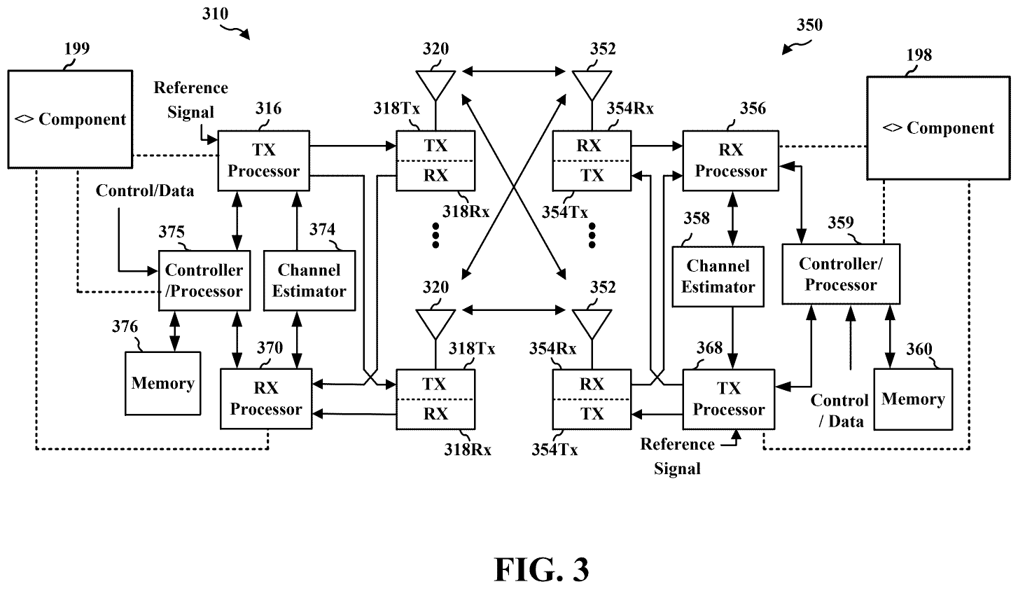

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the sensing component 198 of FIG. 1. At least one of the TX processor 316, the RX processor 370, and the controller/processor 375 may be configured to perform aspects in connection with the sensing component 199 of FIG. 1.

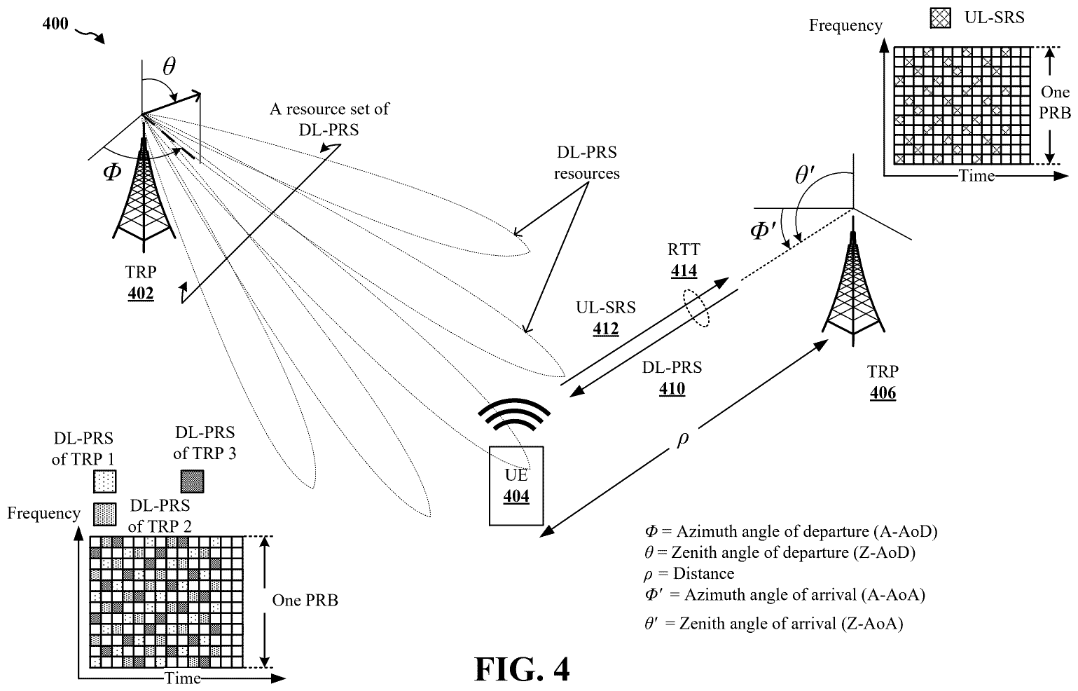

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}-T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}-T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Aspects of wireless communication may utilize a number of different types of communication, such as integrated sensing and communication (ISAC). ISAC refers to a combination of sensing and communication systems in order to utilize wireless resources efficiently and/or utilize wide area environment sensing. ISAC has resulted in a number of technological advances in signal processing and wireless communication. For instance, the combined use of millimeter wave (mmW) frequencies and massive multiple-input multiple-out (MIMO) technology may result in similarities between communication and radio sensing systems, e.g., similarities in hardware architecture, channel characteristics, and information processing pipeline. Accordingly, it may be possible to extend several radar missions (e.g., angle-of-arrival (AoA) or angle-of-departure (AoD) estimation and moving target tracking) in order to address different communication challenges, such as beam management and resource allocation. Further, certain types of wireless networks (e.g., ultra-dense and cell-free wireless networks) may enable a comprehensive characterization of the propagation environment for ISAC.

ISAC is regarded as one of the key features and technological advancements of certain types of wireless communication (e.g., 5G and 6G). Also, there are several different motivations for the use of ISAC, such as cost effectiveness and spectrum effectiveness. For cost effectiveness, aspects of ISAC may utilize a shared radio frequency (RF) and/or baseband hardware for sensing and communication. For spectrum effectiveness, aspects of ISAC may utilize an always-on availability of spectrum for different types of functions. Additionally, ISAC may utilize a number of different use cases, such as macro-sensing and micro-sensing. For macro-sensing use cases, aspects of ISAC may utilize meteorological monitoring, autonomous driving, dynamic map, low-altitude airspace management (e.g., with unmanned aerial vehicles (UAVs)), intruder detection, etc. For micro-sensing use cases, aspects of ISAC may utilize gesture recognition, vital signal detection, high-resolution imaging, etc. Also, aspects of ISAC may utilize sensing-assisted communication, e.g., beam management.

Some aspects of wireless communication may utilize object sensing. Certain types of object sensing may utilize radar sensing, which may be specified as monostatic sensing and bi-static/multi-static sensing. For example, object sensing or radar sensing may be utilized when sensing certain types of objects (e.g., unmanned aerial vehicles (UAVs)). In object or radar sensing, because of the irregular shape of target objects, reflected signals may be unevenly distributed in all directions. In order to increase the possibility of receiving the reflected sensing signal, some types of UEs (e.g., legacy UEs or sensing-dedicated UEs) may be involved in receiving the reflected signals. This type of object sensing is referred to as UE-assisted sensing, where the UE is referred to as a “sensing UE.” This type of object sensing may be utilized because the quantity of base stations (e.g., gNBs) in the cellular network is smaller than the quantity of UEs. This type of object sensing may also be utilized to sense of other kinds of objects (e.g., planes, vehicles, ships, humans, animals, or any object).

As indicated above, certain types of wireless communication may utilize UAV management (i.e., managing UAVs or other wireless objects to assist with sensing). There are a number of expected benefits of UAV management, such as a lowered deployment cost for existing physical sites for sensing. Additionally, UAV management may result in a reduced hardware cost for shared RF/baseband hardware with a base station (BS). Some types of UAV management may utilize wide area airspace management, which may fit for cooperative sensing and target tracking in wireless systems (e.g., a 5G/6G system).

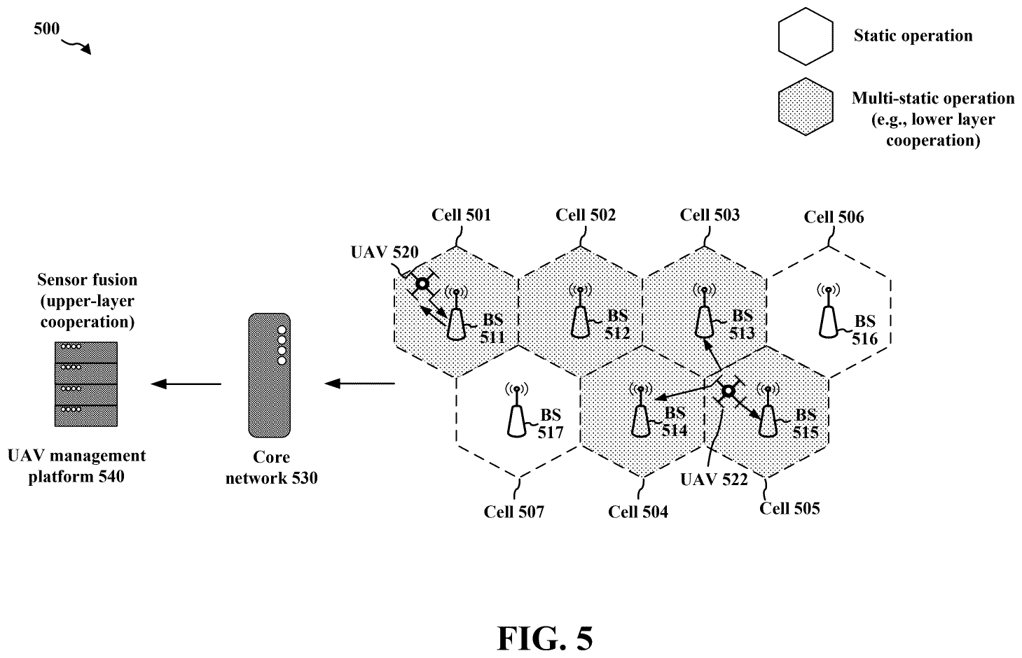

FIG. 5 illustrates diagram 500 including one example of a wireless communication system. More specifically, diagram 500 in FIG. 5 shows an example of wireless communication systems for cooperative sensing and target tracking. As shown in FIG. 5, diagram 500 includes a number of cells (cell 501, cell 502, cell 503, cell 504, cell 505, cell 506, cell 507) and a number of corresponding base stations (base station 511, base station 512, base station 513, base station 514, base station 515, base station 516, base station 517). Diagram 500 also includes UAV 520 and UAV 522, as well as core network 530 and UAV management platform 540. As shown in FIG. 5, cells 501-505 and base stations 511-515 are part of a multi-static operation (i.e., there is lower layer cooperation during the communication between the base stations). Cells 506-507 and base stations 506-507 are in a static operation (i.e., there is no lower layer cooperation between the base stations).

As indicated herein, aspects of object sensing may include monostatic sensing and bi-static/multi-static sensing. In monostatic sensing, one radar/sensor both transmits and receives the sensing signal. Monostatic sensing is advantageous as there may no need to form a transmit (Tx)/receive (Rx) (Tx/Rx) pairing or grouping. However, there may be a need to mitigate self-interference when utilizing monostatic sensing. In bi-static sensing or multi-static sensing, one radar/sensor transmits the sensing signal, and another radar/sensor receives the sensing signal that is reflected by a target object (e.g., a UAV). While bi-static/multi-static sensing may not need to mitigate self-interference, there may be a need to form a Tx/Rx pairing/grouping.

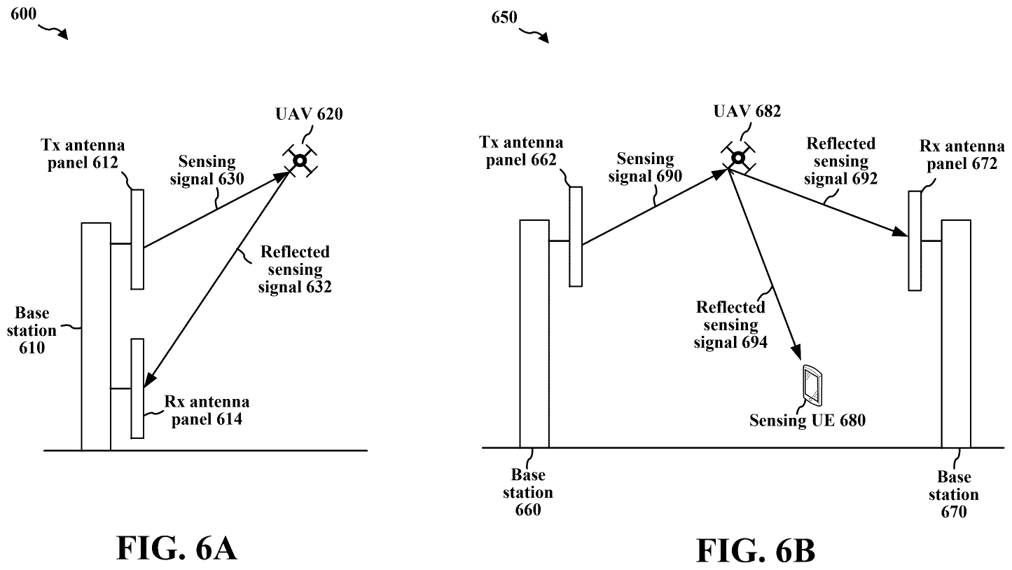

FIG. 6A and FIG. 6B illustrates diagram 600 and diagram 650, respectively, including examples of a wireless communication system utilizing monostatic sensing and bi-static/multi-static sensing. More specifically, diagram 600 in FIG. 6A shows an example of a wireless communication system utilizing monostatic sensing. As shown in FIG. 6A, diagram 600 includes base station 610 including Tx antenna panel 612 and Rx antenna panel 614, as well as UAV 620. Diagram 600 shows that sensing signal 630 is transmitted from Tx antenna panel 612 to UAV 620, and reflected sensing signal 632 is reflected from UAV 620 back to Rx antenna panel 614. Diagram 650 in FIG. 6B shows another example of wireless communication systems utilizing bi-static sensing or multi-static sensing. As shown in FIG. 6B, diagram 650 includes base station 660 including Tx antenna panel 662 and base station 670 including Rx antenna panel 672. FIG. 6B also includes sensing UE 680 and UAV 682. Diagram 650 shows that sensing signal 690 is transmitted from Tx antenna panel 662 to UAV 682. Also, reflected sensing signal 692 is forwarded from UAV 682 to Rx antenna panel 672, while reflected sensing signal 694 is forwarded from UAV 682 to sensing UE 680.

One issue of using a communication network to sense a UAV (or other target object) is the short coverage distance when sensing with a single base station or UE. This is because the base station or UE may not transmit a large-bandwidth signal with the same high Tx power as traditional radar. For example, the bandwidth for a base station or UE may be at most tens of MHz, but bandwidth for traditional radar may be several GHz. That is, the Tx power of a base station or UE is lower than traditional radar considering the radiation safety to humans. Therefore, the coverage of one base station or UE may be less than 1 km, but a traditional UAV-monitoring radar's coverage may be tens or hundreds of km. Based on the above, in order to support the wide-area coverage of UAV monitoring, it may be beneficial to utilize multi-cell sensing. That is, considering the movement of UAVs, it may be beneficial to utilize continuous sensing that relies on the consistent cooperation of multiple base stations/UEs in adjacent cells. In order to do so, it may be beneficial to utilize schemes for sensing handover (e.g., sensing UAVs that may cross a cell border) in an ISAC system.

Aspects of the present disclosure may utilize multi-cell sensing (e.g., sensing with multiple cells), such as to support wide-area coverage of UAV monitoring. In some instances, aspects presented herein may utilize continuous sensing that relies on the consistent cooperation of multiple base stations or UEs in adjacent cells. Aspects of the present disclosure may also utilize schemes for a sensing handover (e.g., sensing UAVs that cross a cell border) in an ISAC system. Additionally, aspects of the present disclosure may utilize sensing handover schemes for different use cases, such as different types of sensing node switching. For instance, aspects of the present disclosure may utilize monostatic sensing node switching, bi-static sensing node switching (e.g., bi-static sensing receiver switching or bi-static sensing transmitter switching), or multi-static sensing node switching.

In aspects of wireless communication that utilize monostatic sensing node switching, a sensing node may transmit a sensing signal that reflects back to itself. For instance, in monostatic sensing node switching, a base station or UE may transmit a sensing signal off an object (e.g., a UAV) and back to itself. In bi-static sensing receiver switching, a Tx node may transmit a sensing signal that reflects to different Rx nodes, where the Rx node may change. For example, in bi-static sensing receiver switching, a base station may transmit a sensing signal that reflects off an object (e.g., a UAV) to an Rx node (e.g., another base station or a UE), where the Rx node may change. Also, in bi-static sensing receiver switching, a UE may transmit a sensing signal that reflects off an object (e.g., a UAV) to an Rx node (e.g., another UE or a base station), where the Rx node may change. In bi-static sensing transmitter switching, an Rx node may receive a sensing signal that is reflected from different Tx nodes, where the Tx node may change. For example, in bi-static sensing transmitter switching, a base station may receive a sensing signal that reflects off an object (e.g., a UAV) from a Tx node (e.g., another base station or a UE), where the Tx node may change. Also, in bi-static sensing transmitter switching, a UE may receive a sensing signal that reflects off an object (e.g., a UAV) from a Tx node (e.g., another UE or a base station), where the Tx node may change.

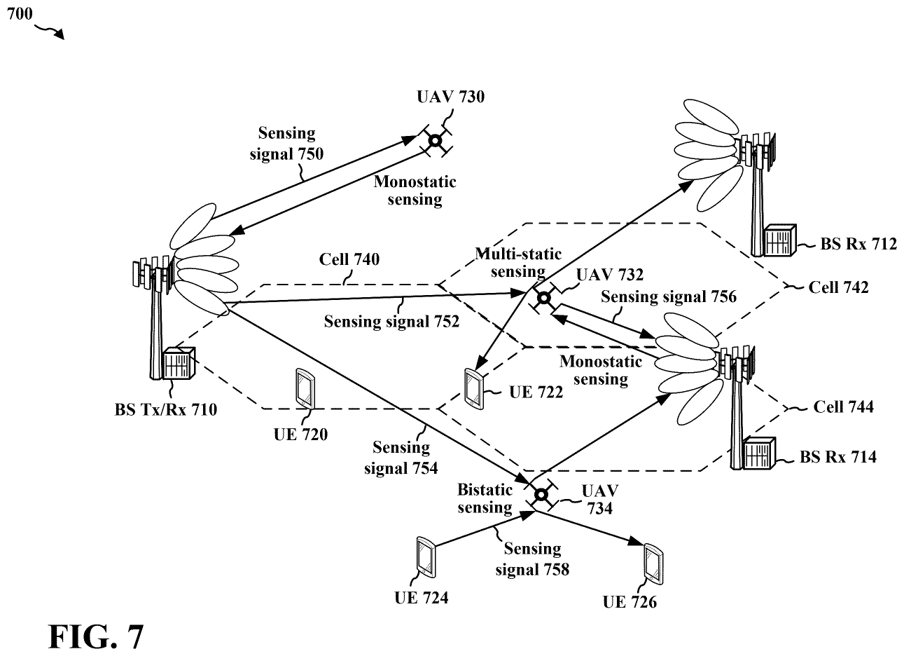

FIG. 7 illustrates diagram 700 including one example of a wireless communication system. More specifically, diagram 700 in FIG. 7 shows an example of a wireless communication system with different sensing handover schemes, such as monostatic sensing, bi-static sensing, and multi-static sensing. As shown in FIG. 7, diagram 700 includes base station Tx/Rx 710, base station Rx 712, base station Rx 714, UE 720, UE 722, UE 724, UE 726, UAV 730, UAV 732, UAV 734, cell 740, cell 742, and cell 744. Diagram 700 also includes a number of sensing signals, such as sensing signal 750, sensing signal 752, sensing signal 754, sensing signal 756, and sensing signal 758. As shown in FIG. 7, base station Tx/Rx 710 may transmit sensing signal 750 that reflects off UAV 730 and goes back to itself, which is an example of monostatic sensing. Also, base station Rx 714 may transmit sensing signal 756 that reflects off UAV 732 and goes back to itself, which is another example of monostatic sensing. Base station Tx/Rx 710 may also transmit sensing signal 752 that reflects off UAV 732 and goes to either base station Rx 712 or UE 722, which is an example of multi-static sensing. Base station Tx/Rx 710 may also transmit sensing signal 754 that reflects off UAV 734 and goes to base station Rx 714, which is an example of bi-static sensing. Further, UE 724 may transmit sensing signal 758 that reflects off UAV 734 and goes to UE 726, which is another example of bi-static sensing.

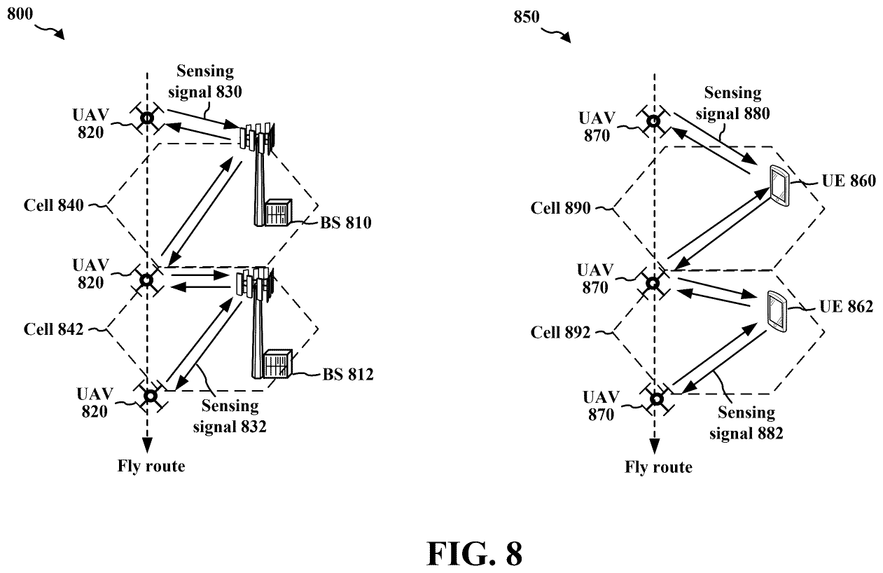

FIG. 8 illustrates diagram 800 and diagram 850 including examples of a wireless communication system. More specifically, diagram 800 and diagram 850 in FIG. 8 show examples of a wireless communication system including a monostatic sensing node switching scheme. As shown in FIG. 8, diagram 800 includes base station 810, base station 812, UAV 820, sensing signal 830, sensing signal 832, cell 840, and cell 842. Diagram 800 also depicts the fly route for UAV 820, which causes the monostatic sensing scheme to switch nodes as the UAV 820 moves along the fly route. For instance, at the beginning of the fly route, base station 810 transmits sensing signal 830 to UAV 820 and back to itself. As UAV 820 moves further along the fly route, such as in the middle of the fly route, the node is switched from base station 810 to base station 812. In the middle of the fly route, UAV 820 may receive sensing signal 830 from base station 810 or sensing signal 832 from base station 812. At the end of the fly route, base station 812 transmits sensing signal 832 to UAV 820 and back to itself.

As further shown in FIG. 8, diagram 850 includes UE 860, UE 862, UAV 870, sensing signal 880, sensing signal 882, cell 890, and cell 892. Diagram 850 also depicts the fly route for UAV 870, which causes the monostatic sensing scheme to switch nodes as the UAV 870 moves along the fly route. For instance, at the beginning of the fly route, UE 860 transmits sensing signal 880 to UAV 870 and back to itself. As UAV 870 moves further along the fly route, such as in the middle of the fly route, the node is switched from UE 860 to UE 862. In the middle of the fly route, UAV 870 may receive sensing signal 880 from UE 860 or sensing signal 882 from UE 862. At the end of the fly route, UE 862 transmits sensing signal 882 to UAV 820 and back to itself. FIG. 8 depicts that as a UAV moves along a route/path, two monostatic sensing base stations/UEs may transmit and receive sensing signals in sequence. As such, the monostatic sensing node switching scheme in FIG. 8 may indicate a UAV position/speed/Doppler frequency profile that may accelerate beam acquisition/tracking and object recognition, and thus reduce sensing interruption.

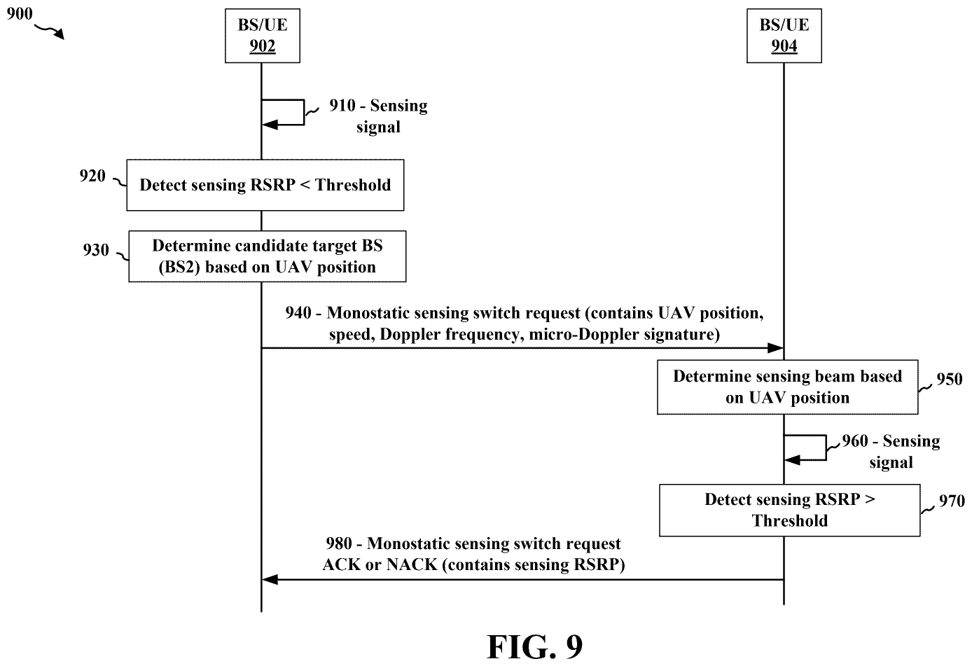

FIG. 9 illustrates diagram 900 including one example of a communication flow for a wireless communication system. More specifically, diagram 900 in FIG. 9 shows an example of a communication flow for a monostatic sensing node switching scheme. As shown in FIG. 9, diagram 900 includes a communication flow diagram between base station/UE 902 (a base station or a UE) and base station/UE 904 (a base station or a UE). At 910, base station/UE 902 may transmit and/or receive a sensing signal. At 920, base station/UE 902 may detect whether a sensing RSRP is less than a threshold. At 930, base station/UE 902 may determine or identify a candidate target base station (e.g., second base station) based on a UAV position. At 940, base station/UE 902 may transmit a monostatic sensing switch request that includes a number of parameters/measurements (e.g., UAV position, speed, Doppler frequency, micro-Doppler signature, etc.). Likewise, at 940, base station/UE 904 may receive a monostatic sensing request that switch includes a number of parameters/measurements (e.g., UAV position, speed, Doppler frequency, micro-Doppler signature, etc.). At 950, base station/UE 904 may determine or select a sensing beam based on a UAV position. At 960, base station/UE 904 may transmit and/or receive a sensing signal. At 970, base station/UE 904 detect whether a sensing RSRP is greater than a threshold. At 980, base station/UE 904 may transmit a monostatic sensing switch request acknowledgement (ACK) or negative ACK (NACK) that includes a number of parameters/measurements (e.g., sensing RSRP, etc.). Likewise, at 980, base station/UE 902 may receive a monostatic sensing switch request ACK or NACK that includes a number of parameters/measurements (e.g., sensing RSRP, etc.).

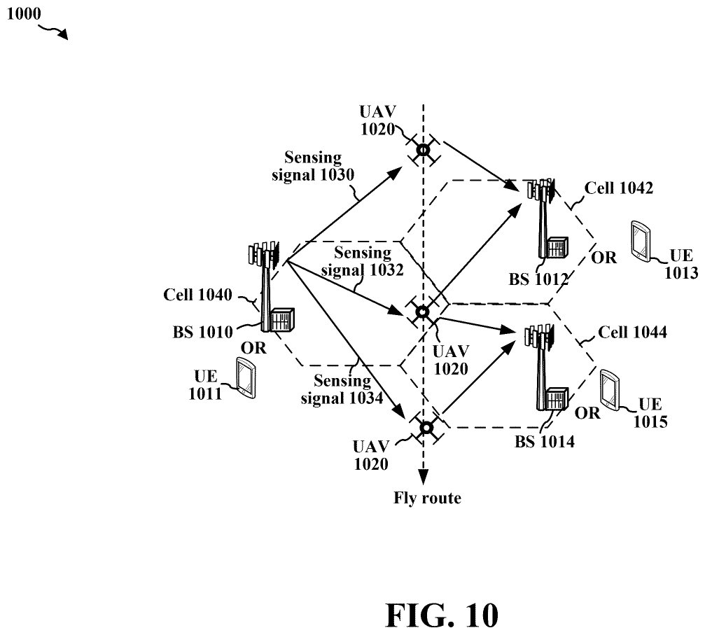

FIG. 10 illustrates diagram 1000 including examples of a wireless communication system. More specifically, diagram 1000 in FIG. 10 shows an example of a wireless communication system including a bi-static sensing receiver node switching scheme. As shown in FIG. 10, diagram 1000 includes base station 1010, UE 1011, base station 1012, UE 1013, base station 1014, UE 1015, UAV 1020, sensing signal 1030, sensing signal 1032, sensing signal 1034, cell 1040, cell 1042, and cell 1044. Diagram 1000 also depicts the fly route for UAV 1020, which causes the bi-static sensing scheme to switch receiver nodes as the UAV 1020 moves along the fly route. For instance, at the beginning of the fly route, base station 1010 or UE 1011 transmits sensing signal 1030 to base station 1012 or UE 1013 via UAV 1020. As UAV 1020 moves further along the fly route, such as in the middle of the fly route, the receiver node is switched from base station 1012 or UE 1013 to base station 1014 or UE 1015. That is, in the middle of the fly route, base station 1010/UE 1011 transmits sensing signal 1032 to base station 1012/UE 1013 via UAV 1020, or base station 1010/UE 1011 transmits sensing signal 1032 to base station 1014/UE 1015 via UAV 1020. At the end of the fly route, base station 1010/UE 1011 transmits sensing signal 1034 to base station 1014/UE 1015 via UAV 1020. Accordingly, the receiver is switched from base station 1012/UE 1013 to base station 1014/UE 1015 as the UAV 1020 moves along the fly route. FIG. 10 depicts that as a UAV moves along a route/path, multiple bi-static sensing Rx base stations/UEs (base station 1012/UE 1013 or base station 1014/UE 1015) may receive sensing signals from one sensing Tx base station/UE (base station 1010/UE 1011) in sequence. As such, the bi-static sensing Rx node switching scheme in FIG. 10 may indicate a UAV position/speed/Doppler frequency profile and may accelerate beam acquisition/tracking and object recognition, and thus reduce sensing interruption.

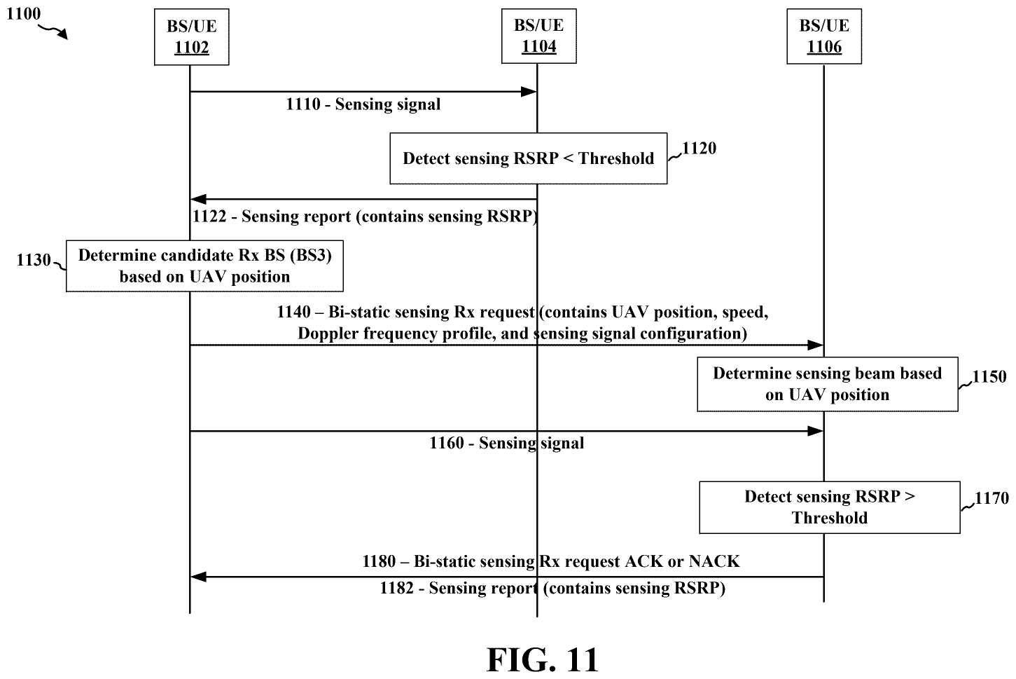

FIG. 11 illustrates diagram 1100 including one example of a communication flow for a wireless communication system. More specifically, diagram 1100 in FIG. 11 shows an example of a communication flow for a bi-static sensing receiver node switching scheme. As shown in FIG. 11, diagram 1100 includes a communication flow diagram between base station/UE 1102 (base station or UE), base station/UE 1104 (base station or UE), and base station/UE 1106 (base station or UE). At 1110, base station/UE 1102 may transmit a sensing signal to base station/UE 1104. At 1120, base station/UE 1104 may detect whether a sensing RSRP is less than a threshold. At 1122, base station/UE 1104 may transmit a sensing report (including a sensing RSRP) to base station/UE 1102. At 1130, base station/UE 1102 may determine or identify a candidate Rx base station (e.g., third base station) based on a UAV position. At 1140, base station/UE 1102 may transmit a bi-static sensing Rx request that includes a number of parameters/measurements (e.g., UAV position, speed, Doppler frequency profile, sensing signal configuration, etc.). Likewise, at 1140, base station/UE 1106 may receive a monostatic sensing Rx request that includes a number of parameters/measurements (e.g., UAV position, speed, Doppler frequency profile, sensing signal configuration, etc.). At 1150, base station/UE 1106 may determine or select a sensing beam based on a UAV position. At 1160, base station/UE 1102 may transmit a sensing signal to base station/UE 1106. At 1170, base station/UE 1106 may detect whether a sensing RSRP is greater than a threshold. At 1180, base station/UE 1106 may transmit a bi-static sensing Rx request acknowledgement (ACK) or negative ACK (NACK). Likewise, at 1180, base station/UE 1102 may receive a bi-static sensing Rx request ACK or NACK. At 1182, base station/UE 1106 may transmit a sensing report that includes a number of parameters or measurements (e.g., sensing RSRP, etc.). Likewise, at 1182, base station/UE 1102 may receive a sensing report that includes a number of parameters or measurements (e.g., sensing RSRP, etc.).

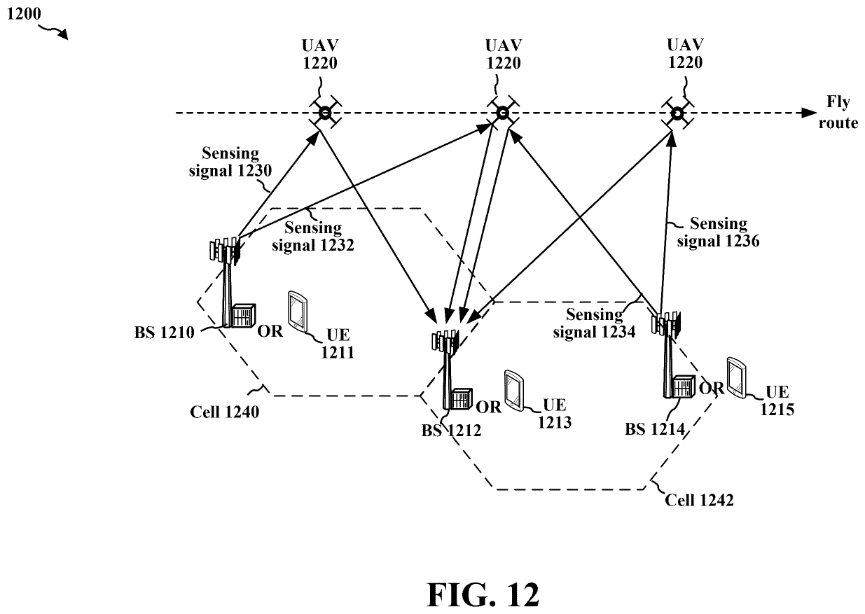

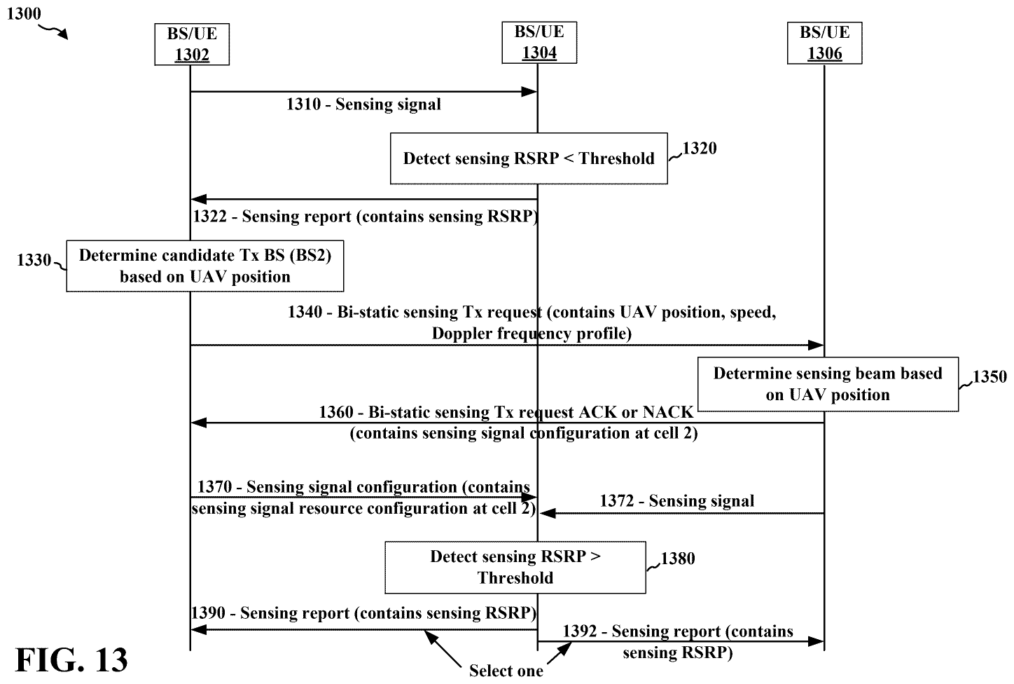

FIG. 12 illustrates diagram 1200 including examples of a wireless communication system. More specifically, diagram 1200 in FIG. 12 shows an example of a wireless communication system including a bi-static sensing transmitter node switching scheme. As shown in FIG. 12, diagram 1200 includes base station 1210, UE 1211, base station 1212, UE 1213, base station 1214, UE 1215, UAV 1220, sensing signal 1230, sensing signal 1232, sensing signal 1234, sensing signal 1236, cell 1240, and cell 1242. Diagram 1200 also depicts a fly route for UAV 1220, which causes the bi-static sensing scheme to switch transmitter nodes as the UAV 1220 moves along the fly route. For instance, at the beginning of the fly route, base station 1210 or UE 1211 transmits sensing signal 1230 to base station 1212 or UE 1213 via UAV 1220. As UAV 1220 moves further along the fly route, such as in the middle of the fly route, the transmitter node is switched from base station 1210 or UE 1211 to base station 1214 or UE 1215. That is, in the middle of the fly route, base station 1210/UE 1211 transmits sensing signal 1232 to base station 1212/UE 1213 via UAV 1220, or base station 1214/UE 1215 transmits sensing signal 1234 to base station 1212/UE 1213 via UAV 1220. At the end of the fly route, base station 1214/UE 1215 transmits sensing signal 1236 to base station 1212/UE 1213 via UAV 1220. Accordingly, the transmitter is switched from base station 1210/UE 1211 to base station 1214/UE 1215 as the UAV 1220 moves along the fly route. FIG. 12 depicts that as a UAV moves along a route/path, one bi-static sensing Rx base station/UE (base station 1212/UE 1213) may receive sensing signals from multiple sensing Tx base stations/UEs (base station 1210/UE 1211 or base station 1214/UE 1215) in sequence. Also, the receiving node may connect to either transmitting node when it reports the sensing result. As such, the bi-static sensing Tx node switching scheme in FIG. 12 may indicate a UAV position/speed/Doppler frequency profile and may accelerate beam acquisition/tracking and object recognition, and thus reduce sensing interruption. FIG. 13 illustrates diagram 1300 including one example of a communication flow for a wireless communication system. More specifically, diagram 1300 in FIG. 13 shows an example of a communication flow for a bi-static sensing transmitter node switching scheme. As shown in FIG. 13, diagram 1300 includes a communication flow diagram between base station/UE 1302 (base station or UE), base station/UE 1304 (base station or UE), and base station/UE 1306 (base station or UE). At 1310, base station/UE 1302 may transmit a sensing signal to base station/UE 1304. At 1320, base station/UE 1304 may detect whether a sensing RSRP is less than a threshold. At 1322, base station/UE 1304 may transmit a sensing report (including a sensing RSRP) to base station/UE 1302. At 1330, base station/UE 1302 may determine or identify a candidate Tx base station (e.g., second base station) based on a UAV position. At 1340, base station/UE 1302 may transmit a bi-static sensing Tx request that includes a number of parameters/measurements (e.g., UAV position, speed, Doppler frequency profile, etc.). At 1350, base station/UE 1306 may determine or select a sensing beam based on a UAV position. At 1360, base station/UE 1306 may transmit a bi-static sensing Tx request ACK or NACK (including a sensing signal configuration at a second cell) to base station/UE 1302. At 1370, base station/UE 1302 may transmit a sensing signal configuration (including a sensing signal resource configuration at a second cell) to base station/UE 1304. At 1372, base station/UE 1306 may transmit a sensing signal to base station/UE 1304. At 1380, base station/UE 1304 may detect whether a sensing RSRP is greater than a threshold. At 1390, base station/UE 1304 may transmit a sensing report that includes a number of parameters/measurements (e.g., sensing RSRP, etc.) to base station/UE 1302. At 1392, base station/UE 1304 may also transmit a sensing report that includes a number of parameters/measurements (e.g., sensing RSRP, etc.) to base station/UE 1306.

Aspects of the present disclosure may include a number of benefits or advantages. For instance, during sensing handover, aspects presented herein may indicate UAV position/speed/Doppler frequency profile from a source sensing node to a target sensing node. By doing so, aspects presented herein may accelerate beam acquisition/tracking and object recognition at a target sensing node. Additionally, by utilizing different types of sensing node switching, aspects presented herein may reduce sensing interruption. For example, by utilizing monostatic sensing node switching, bi-static sensing node switching (e.g., bi-static sensing receiver switching or bi-static sensing transmitter switching), or multi-static sensing node switching, the amount of sensing interruption may be reduced.

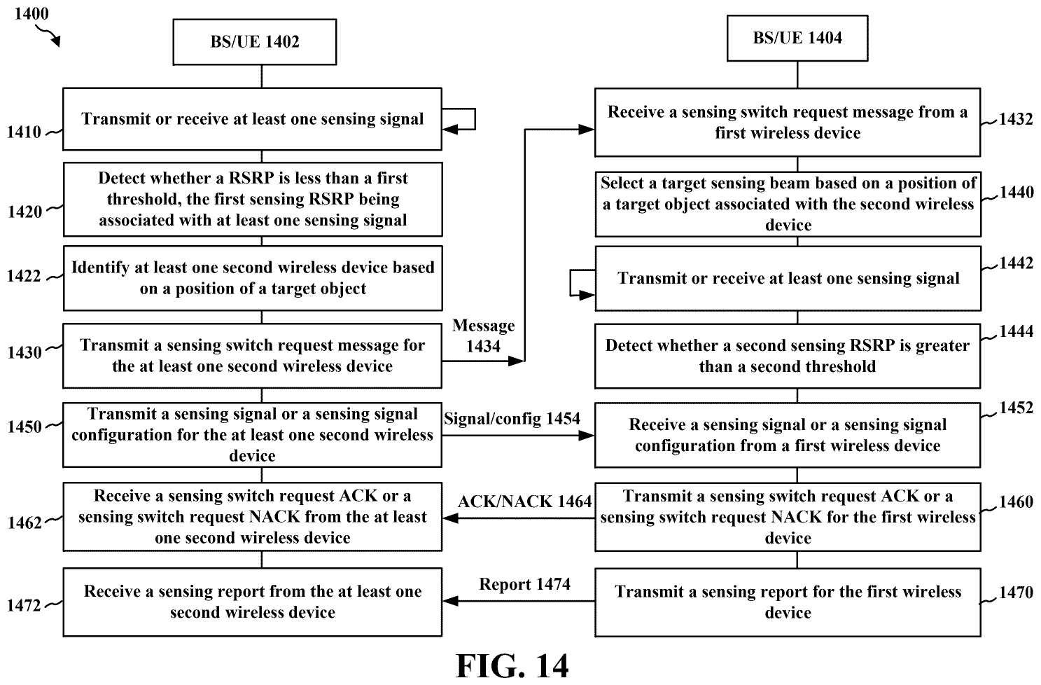

FIG. 14 is a communication flow diagram 1400 of wireless communication in accordance with one or more techniques of this disclosure. As shown in FIG. 14, diagram 1400 includes example communications between base station/UE 1402 (base station or UE) and base station/UE 1404 (base station or UE), in accordance with one or more techniques of this disclosure. In some aspects, base station/UE 1402 may be a first wireless device and base station/UE 1404 may be a second wireless device.

At 1410, base station/UE 1402 may transmit or receive at least one sensing signal, where a first sensing reference signal received power (RSRP) is detected based on the transmitted at least one sensing signal or the received at least one sensing signal.

At 1420, base station/UE 1402 may detect whether a first sensing RSRP is less than a first threshold, the first sensing RSRP being associated with at least one sensing signal.

At 1422, base station/UE 1402 may identify, upon detecting whether the first sensing RSRP is less than the first threshold, at least one second wireless device of a set of candidate second wireless devices, where the at least one second wireless device is identified based on a position of a target object. The first wireless device may be a first user equipment (UE) or a first base station, and the at least one second wireless device may include one or more of: at least one second receive (Rx) UE, at least one second Rx base station, at least one second transmit (Tx) UE, or at least one second Tx base station. In some aspects, the at least one second Tx UE or the at least one second Tx base station may be static over a sensing time period, and the at least one second Rx UE or the at least one second Rx base station may change over the sensing time period. Also, the at least one second Rx UE or the at least one second Rx base station may be static over a sensing time period, and the at least one second Tx UE or the at least one second Tx base station may change over the sensing time period. The target object may be at least one of: an unmanned aerial vehicle (UAV), a user equipment (UE), a base station, a first object with a communication function, or a second object without the communication function.

At 1430, base station/UE 1402 may transmit a sensing switch request message for the at least one second wireless device (e.g., message 1434). The sensing switch request message may be transmitted if the first sensing RSRP is less than the first threshold. The sensing switch request message may include at least one of: the position of the target object, a speed of the target object, a Doppler frequency profile of the target object, a micro-Doppler signature of the target object, or a sensing signal configuration. At 1432, base station/UE 1404 may receive a sensing switch request message from a first wireless device (e.g., message 1434), the sensing switch request message being based on whether a first sensing reference signal received power (RSRP) is less than a first threshold. The sensing switch request message may be received if the first sensing RSRP is less than the first threshold. The sensing switch request message may include at least one of: the position of the target object, a speed of the target object, a Doppler frequency profile of the target object, a micro-Doppler signature of the target object, or a sensing signal configuration.

At 1440, base station/UE 1404 may select a target sensing beam from a set of candidate target sensing beams based on a position of a target object associated with the second wireless device. The first wireless device may be a first user equipment (UE) or a first base station, and the second wireless device may include one or more of: a second receive (Rx) UE, a second Rx base station, a second transmit (Tx) UE, or a second Tx base station. In some aspects, the second Tx UE or the second Tx base station may be static over a sensing time period, and the second Rx UE or the second Rx base station may change over the sensing time period. Also, the second Rx UE or the second Rx base station may be static over a sensing time period, and the second Tx UE or the second Tx base station may change over the sensing time period. The target object may be at least one of: an unmanned aerial vehicle (UAV), a user equipment (UE), a base station, a first object with a communication function, or a second object without the communication function.

At 1442, base station/UE 1404 may transmit or receive the at least one sensing signal, where the second sensing RSRP is detected based on the transmitted at least one sensing signal or the received at least one sensing signal.

At 1444, base station/UE 1404 may detect whether a second sensing RSRP is greater than a second threshold, where the second sensing RSRP is associated with at least one sensing signal.

At 1450, base station/UE 1402 may transmit, based on the sensing switch request message, a sensing signal or a sensing signal configuration for the at least one second wireless device (e.g., signal/configuration 1454). At 1452, base station/UE 1404 may receive, based on detecting whether the second sensing RSRP is greater than the second threshold, a sensing signal or a sensing signal configuration from the first wireless device (e.g., signal/configuration 1454).

At 1460, base station/UE 1404 may transmit, upon detecting whether the second sensing RSRP is greater than the second threshold, a sensing switch request acknowledgement (ACK) or a sensing switch request negative ACK (NACK) for the first wireless device (e.g., ACK/NACK 1464). In some aspects, the sensing switch request message may be a monostatic sensing switch request message, the sensing switch request ACK may be a monostatic sensing switch request ACK, and the sensing switch request NACK may be a monostatic sensing switch request NACK. Also, the sensing switch request message may be a bi-static sensing receive (Rx) request message, the sensing switch request ACK may be a bi-static sensing Rx request ACK, and the sensing switch request NACK may be a bi-static sensing RX request NACK. Further, the sensing switch request message may be a bi-static sensing transmit (Tx) request message, the sensing switch request ACK may be a bi-static sensing Tx request ACK, and the sensing switch request NACK may be a bi-static sensing TX request NACK. The sensing switch request ACK may be transmitted if a second sensing RSRP is greater than a second threshold, and the sensing switch request NACK may be transmitted if the second sensing RSRP is less than or equal to the second threshold.

At 1462, base station/UE 1402 may receive, based on the sensing switch request message, a sensing switch request acknowledgement (ACK) or a sensing switch request negative ACK (NACK) from the at least one second wireless device (e.g., ACK/NACK 1464). In some aspects, the sensing switch request message may be a monostatic sensing switch request message, the sensing switch request ACK may be a monostatic sensing switch request ACK, and the sensing switch request NACK may be a monostatic sensing switch request NACK. Also, the sensing switch request message may be a bi-static sensing receive (Rx) request message, the sensing switch request ACK may be a bi-static sensing Rx request ACK, and the sensing switch request NACK may be a bi-static sensing RX request NACK. Further, the sensing switch request message may be a bi-static sensing transmit (Tx) request message, the sensing switch request ACK may be a bi-static sensing Tx request ACK, and the sensing switch request NACK may be a bi-static sensing TX request NACK. The sensing switch request ACK may be received if a second sensing RSRP is greater than a second threshold, and the sensing switch request NACK may be received if the second sensing RSRP is less than or equal to the second threshold.

At 1470, base station/UE 1404 may transmit, based on the sensing switch request ACK or the sensing switch request NACK, a sensing report for the first wireless device (e.g., report 1474). At 1472, base station/UE 1402 may receive, based on the sensing switch request ACK or the sensing switch request NACK, a sensing report from the at least one second wireless device (e.g., report 1474).

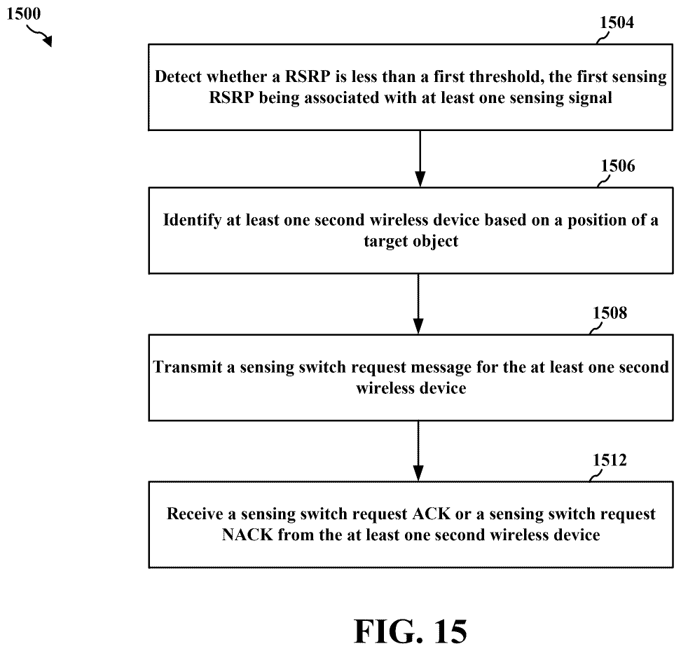

FIG. 15 is a flowchart 1500 of a method of wireless communication. The method may be performed by a first wireless device, such as a UE (e.g., the UE 104; the apparatus 1904) or a base station (e.g., the base station 102; the network entity 2002). The methods described herein may provide a number of benefits, such as improving resource utilization and/or power savings.

At 1504, the first wireless device may detect whether a first sensing RSRP is less than a first threshold, the first sensing RSRP being associated with at least one sensing signal. For example, as described in 1420 of FIG. 14, the first wireless device may detect whether a first sensing RSRP is less than a first threshold, the first sensing RSRP being associated with at least one sensing signal. Further, step 1504 may be performed by sensing component 198.

At 1506, the first wireless device may identify, upon detecting whether the first sensing RSRP is less than the first threshold, at least one second wireless device of a set of candidate second wireless devices, where the at least one second wireless device is identified based on a position of a target object. For example, as described in 1422 of FIG. 14, the first wireless device may identify, upon detecting whether the first sensing RSRP is less than the first threshold, at least one second wireless device of a set of candidate second wireless devices, where the at least one second wireless device is identified based on a position of a target object. Further, step 1506 may be performed by sensing component 198. The first wireless device may be a first user equipment (UE) or a first base station, and the at least one second wireless device may include one or more of: at least one second receive (Rx) UE, at least one second Rx base station, at least one second transmit (Tx) UE, or at least one second Tx base station. In some aspects, the at least one second Tx UE or the at least one second Tx base station may be static over a sensing time period, and the at least one second Rx UE or the at least one second Rx base station may change over the sensing time period. Also, the at least one second Rx UE or the at least one second Rx base station may be static over a sensing time period, and the at least one second Tx UE or the at least one second Tx base station may change over the sensing time period. The target object may be at least one of: an unmanned aerial vehicle (UAV), a user equipment (UE), a base station, a first object with a communication function, or a second object without the communication function.

At 1508, the first wireless device may transmit a sensing switch request message for the at least one second wireless device. For example, as described in 1430 of FIG. 14, the first wireless device may transmit a sensing switch request message for the at least one second wireless device. Further, step 1508 may be performed by sensing component 198. The sensing switch request message may be transmitted if the first sensing RSRP is less than the first threshold. The sensing switch request message may include at least one of: the position of the target object, a speed of the target object, a Doppler frequency profile of the target object, a micro-Doppler signature of the target object, or a sensing signal configuration.

At 1512, the first wireless device may receive, based on the sensing switch request message, a sensing switch request acknowledgement (ACK) or a sensing switch request negative ACK (NACK) from the at least one second wireless device. For example, as described in 1462 of FIG. 14, the first wireless device may receive, based on the sensing switch request message, a sensing switch request acknowledgement (ACK) or a sensing switch request negative ACK (NACK) from the at least one second wireless device. Further, step 1512 may be performed by sensing component 198. In some aspects, the sensing switch request message may be a monostatic sensing switch request message, the sensing switch request ACK may be a monostatic sensing switch request ACK, and the sensing switch request NACK may be a monostatic sensing switch request NACK. Also, the sensing switch request message may be a bi-static sensing receive (Rx) request message, the sensing switch request ACK may be a bi-static sensing Rx request ACK, and the sensing switch request NACK may be a bi-static sensing RX request NACK. Further, the sensing switch request message may be a bi-static sensing transmit (Tx) request message, the sensing switch request ACK may be a bi-static sensing Tx request ACK, and the sensing switch request NACK may be a bi-static sensing TX request NACK. The sensing switch request ACK may be received if a second sensing RSRP is greater than a second threshold, and the sensing switch request NACK may be received if the second sensing RSRP is less than or equal to the second threshold.

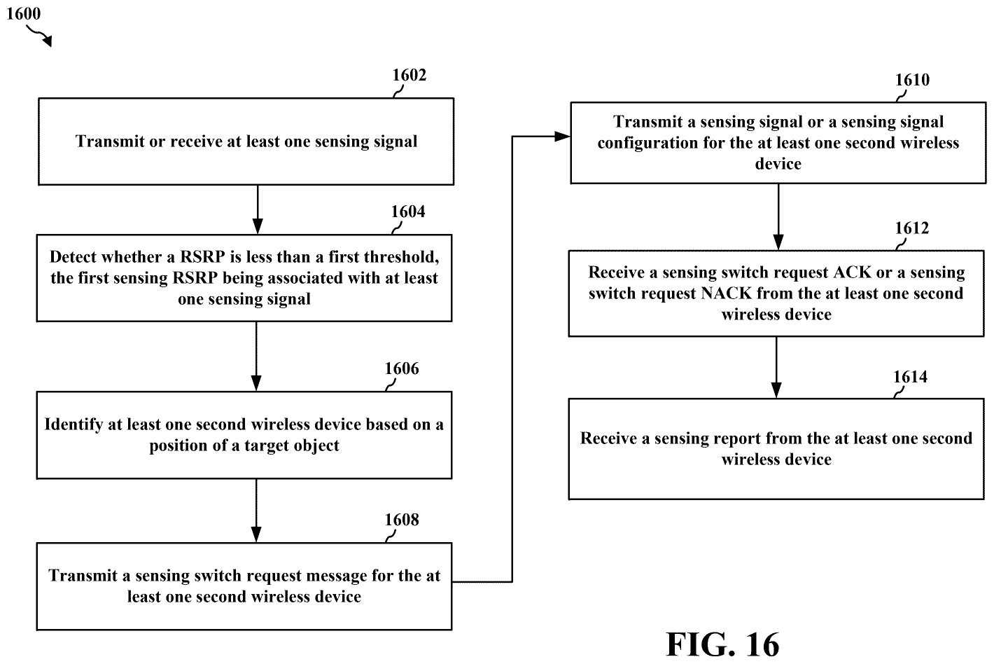

FIG. 16 is a flowchart 1600 of a method of wireless communication. The method may be performed by a first wireless device, such as a UE (e.g., the UE 104; the apparatus 1904) or a base station (e.g., the base station 102; the network entity 2002). The methods described herein may provide a number of benefits, such as improving resource utilization and/or power savings.

At 1602, the first wireless device may transmit or receive at least one sensing signal, where a first sensing reference signal received power (RSRP) is detected based on the transmitted at least one sensing signal or the received at least one sensing signal. For example, as described in 1410 of FIG. 14, the first wireless device may transmit or receive at least one sensing signal, where a first sensing reference signal received power (RSRP) is detected based on the transmitted at least one sensing signal or the received at least one sensing signal. Further, step 1602 may be performed by sensing component 198.

At 1604, the first wireless device may detect whether a first sensing RSRP is less than a first threshold, the first sensing RSRP being associated with at least one sensing signal. For example, as described in 1420 of FIG. 14, the first wireless device may detect whether a first sensing RSRP is less than a first threshold, the first sensing RSRP being associated with at least one sensing signal. Further, step 1604 may be performed by sensing component 198.

At 1606, the first wireless device may identify, upon detecting whether the first sensing RSRP is less than the first threshold, at least one second wireless device of a set of candidate second wireless devices, where the at least one second wireless device is identified based on a position of a target object. For example, as described in 1422 of FIG. 14, the first wireless device may identify, upon detecting whether the first sensing RSRP is less than the first threshold, at least one second wireless device of a set of candidate second wireless devices, where the at least one second wireless device is identified based on a position of a target object. Further, step 1606 may be performed by sensing component 198. The first wireless device may be a first user equipment (UE) or a first base station, and the at least one second wireless device may include one or more of: at least one second receive (Rx) UE, at least one second Rx base station, at least one second transmit (Tx) UE, or at least one second Tx base station. In some aspects, the at least one second Tx UE or the at least one second Tx base station may be static over a sensing time period, and the at least one second Rx UE or the at least one second Rx base station may change over the sensing time period. Also, the at least one second Rx UE or the at least one second Rx base station may be static over a sensing time period, and the at least one second Tx UE or the at least one second Tx base station may change over the sensing time period. The target object may be at least one of: an unmanned aerial vehicle (UAV), a user equipment (UE), a base station, a first object with a communication function, or a second object without the communication function.

At 1608, the first wireless device may transmit a sensing switch request message for the at least one second wireless device. For example, as described in 1430 of FIG. 14, the first wireless device may transmit a sensing switch request message for the at least one second wireless device. Further, step 1608 may be performed by sensing component 198. The sensing switch request message may be transmitted if the first sensing RSRP is less than the first threshold. The sensing switch request message may include at least one of: the position of the target object, a speed of the target object, a Doppler frequency profile of the target object, a micro-Doppler signature of the target object, or a sensing signal configuration.

At 1610, the first wireless device may transmit, based on the sensing switch request message, a sensing signal or a sensing signal configuration for the at least one second wireless device. For example, as described in 1450 of FIG. 14, the first wireless device may transmit, based on the sensing switch request message, a sensing signal or a sensing signal configuration for the at least one second wireless device. Further, step 1610 may be performed by sensing component 198.

At 1612, the first wireless device may receive, based on the sensing switch request message, a sensing switch request acknowledgement (ACK) or a sensing switch request negative ACK (NACK) from the at least one second wireless device. For example, as described in 1462 of FIG. 14, the first wireless device may receive, based on the sensing switch request message, a sensing switch request acknowledgement (ACK) or a sensing switch request negative ACK (NACK) from the at least one second wireless device. Further, step 1612 may be performed by sensing component 198. In some aspects, the sensing switch request message may be a monostatic sensing switch request message, the sensing switch request ACK may be a monostatic sensing switch request ACK, and the sensing switch request NACK may be a monostatic sensing switch request NACK. Also, the sensing switch request message may be a bi-static sensing receive (Rx) request message, the sensing switch request ACK may be a bi-static sensing Rx request ACK, and the sensing switch request NACK may be a bi-static sensing RX request NACK. Further, the sensing switch request message may be a bi-static sensing transmit (Tx) request message, the sensing switch request ACK may be a bi-static sensing Tx request ACK, and the sensing switch request NACK may be a bi-static sensing TX request NACK. The sensing switch request ACK may be received if a second sensing RSRP is greater than a second threshold, and the sensing switch request NACK may be received if the second sensing RSRP is less than or equal to the second threshold.

At 1614, the first wireless device may receive, based on the sensing switch request ACK or the sensing switch request NACK, a sensing report from the at least one second wireless device. For example, as described in 1472 of FIG. 14, the first wireless device may receive, based on the sensing switch request ACK or the sensing switch request NACK, a sensing report from the at least one second wireless device. Further, step 1614 may be performed by sensing component 198.

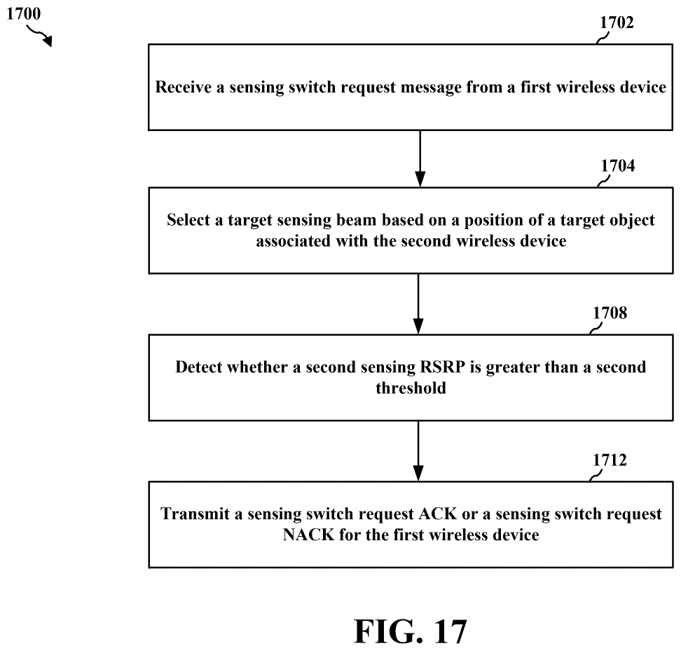

FIG. 17 is a flowchart 1700 of a method of wireless communication. The method may be performed by a second wireless device, such as a UE (e.g., the UE 104; the apparatus 1904) or a base station (e.g., the base station 102; the network entity 2002). The methods described herein may provide a number of benefits, such as improving resource utilization and/or power savings.

At 1702, the second wireless device may receive a sensing switch request message from a first wireless device, the sensing switch request message being based on whether a first sensing reference signal received power (RSRP) is less than a first threshold. For example, as described in 1432 of FIG. 14, the second wireless device may receive a sensing switch request message from a first wireless device, the sensing switch request message being based on whether a first sensing reference signal received power (RSRP) is less than a first threshold. Further, step 1702 may be performed by sensing component 199. The sensing switch request message may be received if the first sensing RSRP is less than the first threshold. The sensing switch request message may include at least one of: the position of the target object, a speed of the target object, a Doppler frequency profile of the target object, a micro-Doppler signature of the target object, or a sensing signal configuration.

At 1704, the second wireless device may select a target sensing beam from a set of candidate target sensing beams based on a position of a target object associated with the second wireless device. For example, as described in 1440 of FIG. 14, the second wireless device may select a target sensing beam from a set of candidate target sensing beams based on a position of a target object associated with the second wireless device. Further, step 1704 may be performed by sensing component 199. The first wireless device may be a first user equipment (UE) or a first base station, and the second wireless device may include one or more of: a second receive (Rx) UE, a second Rx base station, a second transmit (Tx) UE, or a second Tx base station. In some aspects, the second Tx UE or the second Tx base station may be static over a sensing time period, and the second Rx UE or the second Rx base station may change over the sensing time period. Also, the second Rx UE or the second Rx base station may be static over a sensing time period, and the second Tx UE or the second Tx base station may change over the sensing time period. The target object may be at least one of: an unmanned aerial vehicle (UAV), a user equipment (UE), a base station, a first object with a communication function, or a second object without the communication function.

At 1708, the second wireless device may detect whether a second sensing RSRP is greater than a second threshold, where the second sensing RSRP is associated with at least one sensing signal. For example, as described in 1444 of FIG. 14, the second wireless device may detect whether a second sensing RSRP is greater than a second threshold, where the second sensing RSRP is associated with at least one sensing signal. Further, step 1708 may be performed by sensing component 199.

At 1712, the second wireless device may transmit, upon detecting whether the second sensing RSRP is greater than the second threshold, a sensing switch request acknowledgement (ACK) or a sensing switch request negative ACK (NACK) for the first wireless device. For example, as described in 1460 of FIG. 14, the second wireless device may transmit, upon detecting whether the second sensing RSRP is greater than the second threshold, a sensing switch request acknowledgement (ACK) or a sensing switch request negative ACK (NACK) for the first wireless device. Further, step 1712 may be performed by sensing component 199. In some aspects, the sensing switch request message may be a monostatic sensing switch request message, the sensing switch request ACK may be a monostatic sensing switch request ACK, and the sensing switch request NACK may be a monostatic sensing switch request NACK. Also, the sensing switch request message may be a bi-static sensing receive (Rx) request message, the sensing switch request ACK may be a bi-static sensing Rx request ACK, and the sensing switch request NACK may be a bi-static sensing RX request NACK. Further, the sensing switch request message may be a bi-static sensing transmit (Tx) request message, the sensing switch request ACK may be a bi-static sensing Tx request ACK, and the sensing switch request NACK may be a bi-static sensing TX request NACK. The sensing switch request ACK may be transmitted if a second sensing RSRP is greater than a second threshold, and the sensing switch request NACK may be transmitted if the second sensing RSRP is less than or equal to the second threshold.

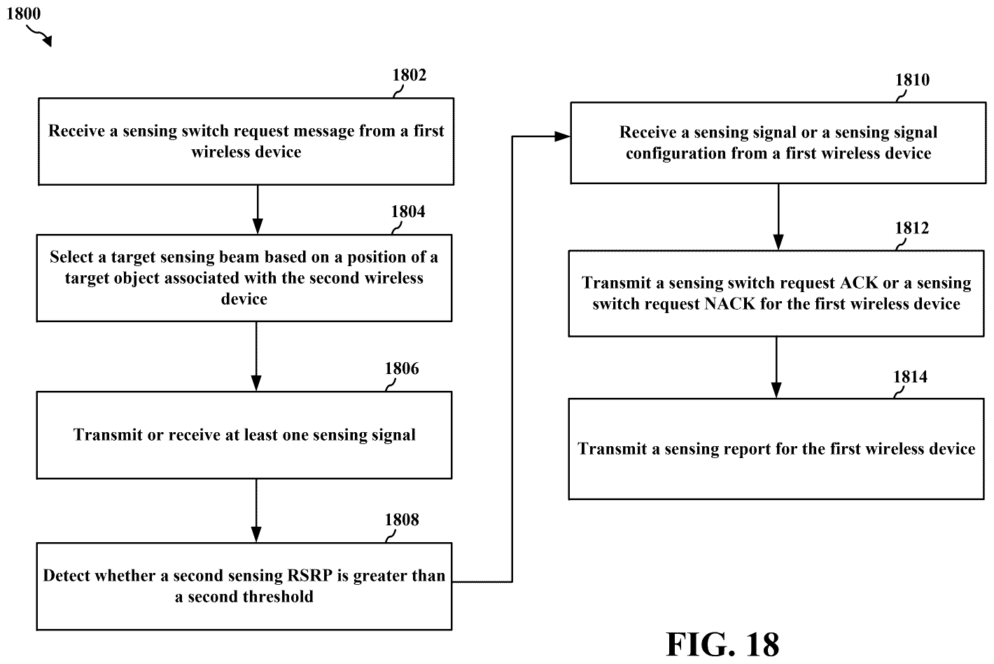

FIG. 18 is a flowchart 1800 of a method of wireless communication. The method may be performed by a second wireless device, such as a UE (e.g., the UE 104; the apparatus 1904) or a base station (e.g., the base station 102; the network entity 2002). The methods described herein may provide a number of benefits, such as improving resource utilization and/or power savings.

At 1802, the second wireless device may receive a sensing switch request message from a first wireless device, the sensing switch request message being based on whether a first sensing reference signal received power (RSRP) is less than a first threshold. For example, as described in 1432 of FIG. 14, the second wireless device may receive a sensing switch request message from a first wireless device, the sensing switch request message being based on whether a first sensing reference signal received power (RSRP) is less than a first threshold. Further, step 1802 may be performed by sensing component 199. The sensing switch request message may be received if the first sensing RSRP is less than the first threshold. The sensing switch request message may include at least one of: the position of the target object, a speed of the target object, a Doppler frequency profile of the target object, a micro-Doppler signature of the target object, or a sensing signal configuration.

At 1804, the second wireless device may select a target sensing beam from a set of candidate target sensing beams based on a position of a target object associated with the second wireless device. For example, as described in 1440 of FIG. 14, the second wireless device may select a target sensing beam from a set of candidate target sensing beams based on a position of a target object associated with the second wireless device. Further, step 1804 may be performed by sensing component 199. The first wireless device may be a first user equipment (UE) or a first base station, and the second wireless device may include one or more of: a second receive (Rx) UE, a second Rx base station, a second transmit (Tx) UE, or a second Tx base station. In some aspects, the second Tx UE or the second Tx base station may be static over a sensing time period, and the second Rx UE or the second Rx base station may change over the sensing time period. Also, the second Rx UE or the second Rx base station may be static over a sensing time period, and the second Tx UE or the second Tx base station may change over the sensing time period. The target object may be at least one of: an unmanned aerial vehicle (UAV), a user equipment (UE), a base station, a first object with a communication function, or a second object without the communication function.

At 1806, the second wireless device may transmit or receive the at least one sensing signal, where the second sensing RSRP is detected based on the transmitted at least one sensing signal or the received at least one sensing signal. For example, as described in 1442 of FIG. 14, the second wireless device may transmit or receive the at least one sensing signal, where the second sensing RSRP is detected based on the transmitted at least one sensing signal or the received at least one sensing signal. Further, step 1806 may be performed by sensing component 199.

At 1808, the second wireless device may detect whether a second sensing RSRP is greater than a second threshold, where the second sensing RSRP is associated with at least one sensing signal. For example, as described in 1444 of FIG. 14, the second wireless device may detect whether a second sensing RSRP is greater than a second threshold, where the second sensing RSRP is associated with at least one sensing signal. Further, step 1808 may be performed by sensing component 199.

At 1810, the second wireless device may receive, based on detecting whether the second sensing RSRP is greater than the second threshold, a sensing signal or a sensing signal configuration from the first wireless device. For example, as described in 1452 of FIG. 14, the second wireless device may receive, based on detecting whether the second sensing RSRP is greater than the second threshold, a sensing signal or a sensing signal configuration from the first wireless device. Further, step 1810 may be performed by sensing component 199.

At 1812, the second wireless device may transmit, upon detecting whether the second sensing RSRP is greater than the second threshold, a sensing switch request acknowledgement (ACK) or a sensing switch request negative ACK (NACK) for the first wireless device. For example, as described in 1460 of FIG. 14, the second wireless device may transmit, upon detecting whether the second sensing RSRP is greater than the second threshold, a sensing switch request acknowledgement (ACK) or a sensing switch request negative ACK (NACK) for the first wireless device. Further, step 1812 may be performed by sensing component 199. In some aspects, the sensing switch request message may be a monostatic sensing switch request message, the sensing switch request ACK may be a monostatic sensing switch request ACK, and the sensing switch request NACK may be a monostatic sensing switch request NACK. Also, the sensing switch request message may be a bi-static sensing receive (Rx) request message, the sensing switch request ACK may be a bi-static sensing Rx request ACK, and the sensing switch request NACK may be a bi-static sensing RX request NACK. Further, the sensing switch request message may be a bi-static sensing transmit (Tx) request message, the sensing switch request ACK may be a bi-static sensing Tx request ACK, and the sensing switch request NACK may be a bi-static sensing TX request NACK. The sensing switch request ACK may be transmitted if a second sensing RSRP is greater than a second threshold, and the sensing switch request NACK may be transmitted if the second sensing RSRP is less than or equal to the second threshold.

At 1814, the second wireless device may transmit, based on the sensing switch request ACK or the sensing switch request NACK, a sensing report for the first wireless device. For example, as described in 1470 of FIG. 14, the second wireless device may transmit, based on the sensing switch request ACK or the sensing switch request NACK, a sensing report for the first wireless device. Further, step 1814 may be performed by sensing component 199.

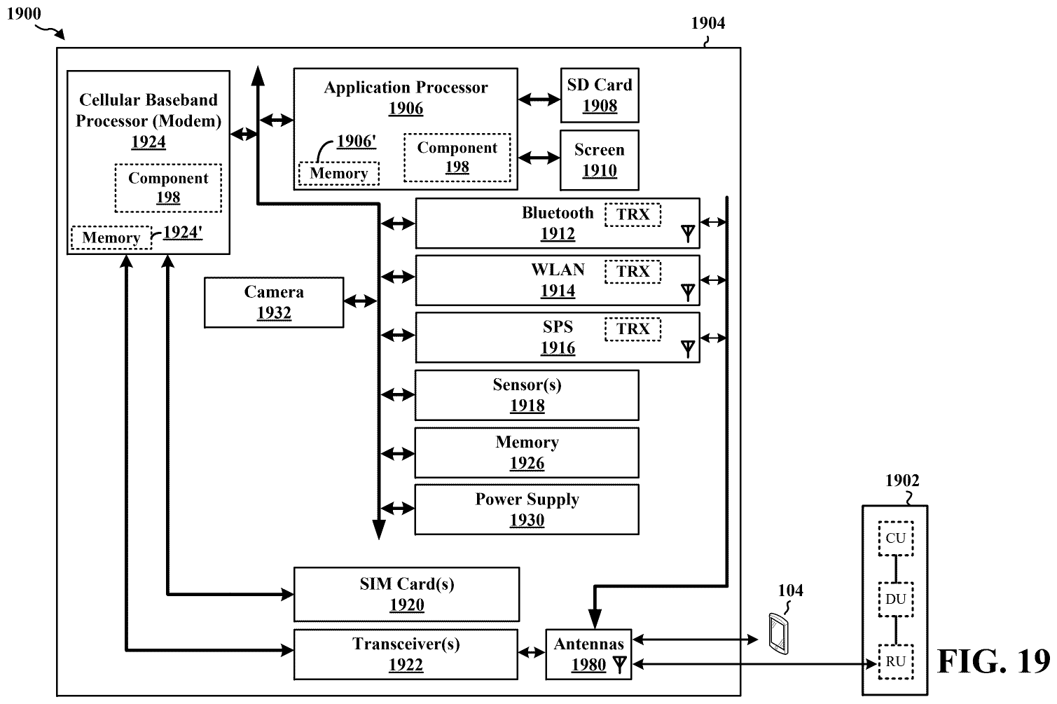

FIG. 19 is a diagram 1900 illustrating an example of a hardware implementation for an apparatus 1904. The apparatus 1904 may be a UE, a component of a UE, or may implement UE functionality. In some aspects, the apparatus 1904 may include a cellular baseband processor 1924 (also referred to as a modem) coupled to one or more transceivers 1922 (e.g., cellular RF transceiver). The cellular baseband processor 1924 may include on-chip memory 1924′. In some aspects, the apparatus 1904 may further include one or more subscriber identity modules (SIM) cards 1920 and an application processor 1906 coupled to a secure digital (SD) card 1908 and a screen 1910. The application processor 1906 may include on-chip memory 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the WLAN module 1914, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize the antennas 1980 for communication. The cellular baseband processor 1924 communicates through the transceiver(s) 1922 via one or more antennas 1980 with the UE 104 and/or with an RU associated with a network entity 1902. The cellular baseband processor 1924 and the application processor 1906 may each include a computer-readable medium/memory 1924′, 1906′, respectively. The additional memory modules 1926 may also be considered a computer-readable medium/memory. Each computer-readable medium/memory 1924′, 1906′, 1926 may be non-transitory. The cellular baseband processor 1924 and the application processor 1906 are each responsible for general processing, including the execution of software stored on the computer-readable medium/memory. The software, when executed by the cellular baseband processor 1924/application processor 1906, causes the cellular baseband processor 1924/application processor 1906 to perform the various functions described supra. The computer-readable medium/memory may also be used for storing data that is manipulated by the cellular baseband processor 1924/application processor 1906 when executing software. The cellular baseband processor 1924/application processor 1906 may be a component of the UE 350 and may include the memory 360 and/or at least one of the TX processor 368, the RX processor 356, and the controller/processor 359. In one configuration, the apparatus 1904 may be a processor chip (modem and/or application) and include just the cellular baseband processor 1924 and/or the application processor 1906, and in another configuration, the apparatus 1904 may be the entire UE (e.g., see 350 of FIG. 3) and include the additional modules of the apparatus 1904.

As discussed supra, the sensing component 198 may be configured to transmit or receive at least one sensing signal, where a first sensing reference signal received power (RSRP) is detected based on the transmitted at least one sensing signal or the received at least one sensing signal. The sensing component 198 may also be configured to detect whether a first sensing RSRP is less than a first threshold, the first sensing RSRP being associated with at least one sensing signal. The sensing component 198 may also be configured to identify, upon detecting whether the first sensing RSRP is less than the first threshold, at least one second wireless device of a set of candidate second wireless devices, where the at least one second wireless device is identified based on a position of a target object. The sensing component 198 may also be configured to transmit a sensing switch request message for the at least one second wireless device. The sensing component 198 may also be configured to transmit, based on the sensing switch request message, a sensing signal or a sensing signal configuration for the at least one second wireless device. The sensing component 198 may also be configured to receive, based on the sensing switch request message, a sensing switch request acknowledgement (ACK) or a sensing switch request negative ACK (NACK) from the at least one second wireless device. The sensing component 198 may also be configured to receive, based on the sensing switch request ACK or the sensing switch request NACK, a sensing report from the at least one second wireless device.

The sensing component 198 may be within the cellular baseband processor 1924, the application processor 1906, or both the cellular baseband processor 1924 and the application processor 1906. The sensing component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1904 may include a variety of components configured for various functions. In one configuration, the apparatus 1904, and in particular the cellular baseband processor 1924 and/or the application processor 1906, includes means for detecting whether a first sensing reference signal received power (RSRP) is less than a first threshold, the first sensing RSRP being associated with at least one sensing signal; means for identifying, upon detecting whether the first sensing RSRP is less than the first threshold, at least one second wireless device of a set of candidate second wireless devices, where the at least one second wireless device is identified based on a position of a target object; means for transmitting a sensing switch request message for the at least one second wireless device; means for receiving, based on the sensing switch request message, a sensing switch request acknowledgement (ACK) or a sensing switch request negative ACK (NACK) from the at least one second wireless device; means for transmitting or means for receiving the at least one sensing signal, where the first sensing RSRP is detected based on the transmitted at least one sensing signal or the received at least one sensing signal; means for transmitting, based on the sensing switch request message, a sensing signal or a sensing signal configuration for the at least one second wireless device; and means for receiving, based on the sensing switch request ACK or the sensing switch request NACK, a sensing report from the at least one second wireless device. The means may be the sensing component 198 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

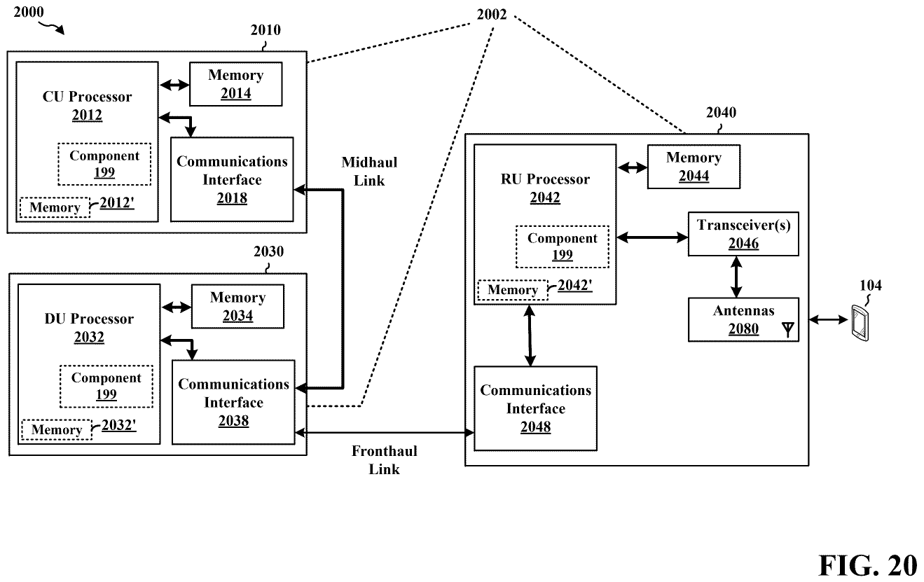

FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. For example, depending on the layer functionality handled by the sensing component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include a CU processor 2012. The CU processor 2012 may include on-chip memory 2012′. In some aspects, the CU 2010 may further include additional memory modules 2014 and a communications interface 2018. The CU 2010 communicates with the DU 2030 through a midhaul link, such as an F1 interface. The DU 2030 may include a DU processor 2032. The DU processor 2032 may include on-chip memory 2032′. In some aspects, the DU 2030 may further include additional memory modules 2034 and a communications interface 2038. The DU 2030 communicates with the RU 2040 through a fronthaul link. The RU 2040 may include an RU processor 2042. The RU processor 2042 may include on-chip memory 2042′. In some aspects, the RU 2040 may further include additional memory modules 2044, one or more transceivers 2046, antennas 2080, and a communications interface 2048. The RU 2040 communicates with the UE 104. The on-chip memory 2012′, 2032′, 2042′ and the additional memory modules 2014, 2034, 2044 may each be considered a computer-readable medium/memory. Each computer-readable medium/memory may be non-transitory. Each of the processors 2012, 2032, 2042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the sensing component 199 may be configured to receive a sensing switch request message from a first wireless device, the sensing switch request message being based on whether a first sensing reference signal received power (RSRP) is less than a first threshold. The sensing component 199 may also be configured to select a target sensing beam from a set of candidate target sensing beams based on a position of a target object associated with the second wireless device. The sensing component 199 may also be configured to transmit or receive the at least one sensing signal, where the second sensing RSRP is detected based on the transmitted at least one sensing signal or the received at least one sensing signal. The sensing component 199 may also be configured to detect whether a second sensing RSRP is greater than a second threshold, where the second sensing RSRP is associated with at least one sensing signal. The sensing component 199 may also be configured to receive, based on detecting whether the second sensing RSRP is greater than the second threshold, a sensing signal or a sensing signal configuration from the first wireless device. The sensing component 199 may also be configured to transmit, upon detecting whether the second sensing RSRP is greater than the second threshold, a sensing switch request acknowledgement (ACK) or a sensing switch request negative ACK (NACK) for the first wireless device. The sensing component 199 may also be configured to transmit, based on the sensing switch request ACK or the sensing switch request NACK, a sensing report for the first wireless device.

The sensing component 199 may be within one or more processors of one or more of the CU 2010, DU 2030, and the RU 2040. The sensing component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2002 may include a variety of components configured for various functions. In one configuration, the network entity 2002 includes means for receiving a sensing switch request message from a first wireless device, the sensing switch request message being based on whether a first sensing reference signal received power (RSRP) is less than a first threshold; means for selecting a target sensing beam from a set of candidate target sensing beams based on a position of a target object associated with the second wireless device; means for detecting whether a second sensing RSRP is greater than a second threshold, where the second sensing RSRP is associated with at least one sensing signal; means for transmitting, upon detecting whether the second sensing RSRP is greater than the second threshold, a sensing switch request acknowledgement (ACK) or a sensing switch request negative ACK (NACK) for the first wireless device; means for transmitting or means for receiving the at least one sensing signal, where the second sensing RSRP is detected based on the transmitted at least one sensing signal or the received at least one sensing signal; means for receiving, based on detecting whether the second sensing RSRP is greater than the second threshold, a sensing signal or a sensing signal configuration from the first wireless device; and means for transmitting, based on the sensing switch request ACK or the sensing switch request NACK, a sensing report for the first wireless device. The means may be the sensing component 199 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof′ include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a first wireless device, including a memory and at least one processor coupled to the memory and, based at least in part on information stored in the memory, the at least one processor is configured to: detect whether a first sensing reference signal received power (RSRP) is less than a first threshold, the first sensing RSRP being associated with at least one sensing signal; identify, upon detecting whether the first sensing RSRP is less than the first threshold, at least one second wireless device of a set of candidate second wireless devices, where the at least one second wireless device is identified based on a position of a target object; transmit a sensing switch request message for the at least one second wireless device; and receive, based on the sensing switch request message, a sensing switch request acknowledgement (ACK) or a sensing switch request negative ACK (NACK) from the at least one second wireless device.

Aspect 2 is the apparatus of aspect 1, where the sensing switch request message is a monostatic sensing switch request message, the sensing switch request ACK is a monostatic sensing switch request ACK, and the sensing switch request NACK is a monostatic sensing switch request NACK.

Aspect 3 is the apparatus of any of aspects 1 and 2, where the sensing switch request message is a bi-static sensing receive (Rx) request message, the sensing switch request ACK is a bi-static sensing Rx request ACK, and the sensing switch request NACK is a bi-static sensing RX request NACK.

Aspect 4 is the apparatus of any of aspects 1 to 3, where the sensing switch request message is a bi-static sensing transmit (Tx) request message, the sensing switch request ACK is a bi-static sensing Tx request ACK, and the sensing switch request NACK is a bi-static sensing TX request NACK.

Aspect 5 is the apparatus of any of aspects 1 to 4, where the first wireless device is a first user equipment (UE) or a first base station, and where the at least one second wireless device includes one or more of: at least one second receive (Rx) UE, at least one second Rx base station, at least one second transmit (Tx) UE, or at least one second Tx base station.

Aspect 6 is the apparatus of any of aspects 1 to 5, where the at least one second Tx UE or the at least one second Tx base station is static over a sensing time period, and where the at least one second Rx UE or the at least one second Rx base station changes over the sensing time period.

Aspect 7 is the apparatus of any of aspects 1 to 6, where the at least one second Rx UE or the at least one second Rx base station is static over a sensing time period, and where the at least one second Tx UE or the at least one second Tx base station changes over the sensing time period.

Aspect 8 is the apparatus of any of aspects 1 to 7, where the at least one processor is further configured to: transmit or receive the at least one sensing signal, where the first sensing RSRP is detected based on the transmitted at least one sensing signal or the received at least one sensing signal.

Aspect 9 is the apparatus of any of aspects 1 to 8, where the at least one processor is further configured to: transmit, based on the sensing switch request message, a sensing signal or a sensing signal configuration for the at least one second wireless device.

Aspect 10 is the apparatus of any of aspects 1 to 9, where the at least one processor is further configured to: receive, based on the sensing switch request ACK or the sensing switch request NACK, a sensing report from the at least one second wireless device.

Aspect 11 is the apparatus of any of aspects 1 to 10, where the sensing switch request message is transmitted if the first sensing RSRP is less than the first threshold.

Aspect 12 is the apparatus of any of aspects 1 to 11, where the sensing switch request ACK is received if a second sensing RSRP is greater than a second threshold, and the sensing switch request NACK is received if the second sensing RSRP is less than or equal to the second threshold.

Aspect 13 is the apparatus of any of aspects 1 to 12, where the sensing switch request message includes at least one of: the position of the target object, a speed of the target object, a Doppler frequency profile of the target object, a micro-Doppler signature of the target object, or a sensing signal configuration.

Aspect 14 is the apparatus of any of aspects 1 to 13, where the target object is at least one of: an unmanned aerial vehicle (UAV), a user equipment (UE), a base station, a first object with a communication function, or a second object without the communication function.

Aspect 15 is an apparatus for wireless communication at a second wireless device, including a memory and at least one processor coupled to the memory and, based at least in part on information stored in the memory, the at least one processor is configured to: receive a sensing switch request message from a first wireless device, the sensing switch request message being based on whether a first sensing reference signal received power (RSRP) is less than a first threshold; select a target sensing beam from a set of candidate target sensing beams based on a position of a target object associated with the second wireless device; detect whether a second sensing RSRP is greater than a second threshold, where the second sensing RSRP is associated with at least one sensing signal; and transmit, upon detecting whether the second sensing RSRP is greater than the second threshold, a sensing switch request acknowledgement (ACK) or a sensing switch request negative ACK (NACK) for the first wireless device.

Aspect 16 is the apparatus of aspect 15, where the sensing switch request message is a monostatic sensing switch request message, the sensing switch request ACK is a monostatic sensing switch request ACK, and the sensing switch request NACK is a monostatic sensing switch request NACK.

Aspect 17 is the apparatus of any of aspects 15 and 16, where the sensing switch request message is a bi-static sensing receive (Rx) request message, the sensing switch request ACK is a bi-static sensing Rx request ACK, and the sensing switch request NACK is a bi-static sensing RX request NACK.

Aspect 18 is the apparatus of any of aspects 15 to 17, where the sensing switch request message is a bi-static sensing transmit (Tx) request message, the sensing switch request ACK is a bi-static sensing Tx request ACK, and the sensing switch request NACK is a bi-static sensing TX request NACK.

Aspect 19 is the apparatus of any of aspects 15 to 18, where the first wireless device is a first user equipment (UE) or a first base station, and where the second wireless device includes one or more of: a second receive (Rx) UE, a second Rx base station, a second transmit (Tx) UE, or a second Tx base station.

Aspect 20 is the apparatus of any of aspects 15 to 19, where the second Tx UE or the second Tx base station is static over a sensing time period, and where the second Rx UE or the second Rx base station changes over the sensing time period.

Aspect 21 is the apparatus of any of aspects 15 to 20, where the second Tx UE or the second Tx base station is static over a sensing time period, and where the second Rx UE or the second Rx base station changes over the sensing time period.

Aspect 22 is the apparatus of any of aspects 15 to 21, where the at least one processor is further configured to: transmit or receive the at least one sensing signal, where the second sensing RSRP is detected based on the transmitted at least one sensing signal or the received at least one sensing signal.

Aspect 23 is the apparatus of any of aspects 15 to 22, where the at least one processor is further configured to: receive, based on detecting whether the second sensing RSRP is greater than the second threshold, a sensing signal or a sensing signal configuration from the first wireless device.

Aspect 24 is the apparatus of any of aspects 15 to 23, where the at least one processor is further configured to: transmit, based on the sensing switch request ACK or the sensing switch request NACK, a sensing report for the first wireless device.

Aspect 25 is the apparatus of any of aspects 15 to 24, where the sensing switch request message is received if the first sensing RSRP is less than the first threshold.

Aspect 26 is the apparatus of any of aspects 15 to 25, where the sensing switch request ACK is transmitted if the second sensing RSRP is greater than the second threshold, and the sensing switch request NACK is transmitted if the second sensing RSRP is less than or equal to the second threshold.

Aspect 27 is the apparatus of any of aspects 15 to 26, where the sensing switch request message includes at least one of: the position of the target object, a speed of the target object, a Doppler frequency profile of the target object, a micro-Doppler signature of the target object, or a sensing signal configuration.

Aspect 28 is the apparatus of any of aspects 15 to 27, where the target object is at least one of: an unmanned aerial vehicle (UAV), a user equipment (UE), a base station, a first object with a communication function, or a second object without the communication function.

Aspect 29 is the apparatus of any of aspects 1 to 28, where the apparatus is a wireless communication device, further including at least one of an antenna or a transceiver coupled to the at least one processor.

Aspect 30 is a method of wireless communication for implementing any of aspects 1 to 29.

Aspect 31 is an apparatus for wireless communication including means for implementing any of aspects 1 to 29.

Aspect 32 is a computer-readable medium (e.g., a non-transitory computer-readable medium) storing computer executable code, the code when executed by at least one processor causes the at least one processor to implement any of aspects 1 to 29.

What is claimed is:

1. An apparatus for wireless communication at a first wireless device, comprising:
a memory; and
at least one processor coupled to the memory and, based at least in part on information stored in the memory, the at least one processor is configured to:
detect whether a first sensing reference signal received power (RSRP) is less than a first threshold, the first sensing RSRP being associated with at least one sensing signal;
identify, upon detecting whether the first sensing RSRP is less than the first threshold, at least one second wireless device of a set of candidate second wireless devices, wherein the at least one second wireless device is identified based on a position of a target object;
transmit a sensing switch request message for the at least one second wireless device; and
receive, based on the sensing switch request message, a sensing switch request acknowledgement (ACK) or a sensing switch request negative ACK (NACK) from the at least one second wireless device.

2. The apparatus of claim 1, wherein the sensing switch request message is a monostatic sensing switch request message, the sensing switch request ACK is a monostatic sensing switch request ACK, and the sensing switch request NACK is a monostatic sensing switch request NACK.

3. The apparatus of claim 1, wherein the sensing switch request message is a bi-static sensing receive (Rx) request message, the sensing switch request ACK is a bi-static sensing Rx request ACK, and the sensing switch request NACK is a bi-static sensing RX request NACK.

4. The apparatus of claim 1, wherein the sensing switch request message is a bi-static sensing transmit (Tx) request message, the sensing switch request ACK is a bi-static sensing Tx request ACK, and the sensing switch request NACK is a bi-static sensing TX request NACK.

5. The apparatus of claim 1, wherein the first wireless device is a first user equipment (UE) or a first base station, and wherein the at least one second wireless device includes one or more of: at least one second receive (Rx) UE, at least one second Rx base station, at least one second transmit (Tx) UE, or at least one second Tx base station.

6. The apparatus of claim 5, wherein the at least one second Tx UE or the at least one second Tx base station is static over a sensing time period, and wherein the at least one second Rx UE or the at least one second Rx base station changes over the sensing time period.

7. The apparatus of claim 5, wherein the at least one second Rx UE or the at least one second Rx base station is static over a sensing time period, and wherein the at least one second Tx UE or the at least one second Tx base station changes over the sensing time period.

8. The apparatus of claim 1, wherein the at least one processor is further configured to:
transmit or receive the at least one sensing signal, wherein the first sensing RSRP is detected based on the transmitted at least one sensing signal or the received at least one sensing signal.

9. The apparatus of claim 1, wherein the at least one processor is further configured to:
transmit, based on the sensing switch request message, a sensing signal or a sensing signal configuration for the at least one second wireless device.

10. The apparatus of claim 1, wherein the at least one processor is further configured to:
receive, based on the sensing switch request ACK or the sensing switch request NACK, a sensing report from the at least one second wireless device.

11. The apparatus of claim 1, wherein the sensing switch request message is transmitted if the first sensing RSRP is less than the first threshold.

12. The apparatus of claim 1, wherein the sensing switch request ACK is received if a second sensing RSRP is greater than a second threshold, and the sensing switch request NACK is received if the second sensing RSRP is less than or equal to the second threshold.

13. The apparatus of claim 1, wherein the sensing switch request message includes at least one of: the position of the target object, a speed of the target object, a Doppler frequency profile of the target object, a micro-Doppler signature of the target object, or a sensing signal configuration.

14. The apparatus of claim 1, wherein the target object is at least one of: an unmanned aerial vehicle (UAV), a user equipment (UE), a base station, a first object with a communication function, or a second object without the communication function.

15. An apparatus for wireless communication at a second wireless device, comprising:
a memory; and
at least one processor coupled to the memory and, based at least in part on information stored in the memory, the at least one processor is configured to:
receive a sensing switch request message from a first wireless device, the sensing switch request message being based on whether a first sensing reference signal received power (RSRP) is less than a first threshold;
select a target sensing beam from a set of candidate target sensing beams based on a position of a target object associated with the second wireless device;
detect whether a second sensing RSRP is greater than a second threshold,
wherein the second sensing RSRP is associated with at least one sensing signal; and
transmit, upon detecting whether the second sensing RSRP is greater than the second threshold, a sensing switch request acknowledgement (ACK) or a sensing switch request negative ACK (NACK) for the first wireless device.

16. The apparatus of claim 15, wherein the sensing switch request message is a monostatic sensing switch request message, the sensing switch request ACK is a monostatic sensing switch request ACK, and the sensing switch request NACK is a monostatic sensing switch request NACK.

17. The apparatus of claim 15, wherein the sensing switch request message is a bi-static sensing receive (Rx) request message, the sensing switch request ACK is a bi-static sensing Rx request ACK, and the sensing switch request NACK is a bi-static sensing RX request NACK.

18. The apparatus of claim 15, wherein the sensing switch request message is a bi-static sensing transmit (Tx) request message, the sensing switch request ACK is a bi-static sensing Tx request ACK, and the sensing switch request NACK is a bi-static sensing TX request NACK.

19. The apparatus of claim 15, wherein the first wireless device is a first user equipment (UE) or a first base station, and wherein the second wireless device includes one or more of: a second receive (Rx) UE, a second Rx base station, a second transmit (Tx) UE, or a second Tx base station.

20. The apparatus of claim 19, wherein the second Tx UE or the second Tx base station is static over a sensing time period, and wherein the second Rx UE or the second Rx base station changes over the sensing time period.

21. The apparatus of claim 19, wherein the second Rx UE or the second Rx base station is static over a sensing time period, and wherein the second Tx UE or the second Tx base station changes over the sensing time period.

22. The apparatus of claim 15, wherein the at least one processor is further configured to:
transmit or receive the at least one sensing signal, wherein the second sensing RSRP is detected based on the transmitted at least one sensing signal or the received at least one sensing signal.

23. The apparatus of claim 15, wherein the at least one processor is further configured to:
receive, based on detecting whether the second sensing RSRP is greater than the second threshold, a sensing signal or a sensing signal configuration from the first wireless device.

24. The apparatus of claim 15, wherein the at least one processor is further configured to:
transmit, based on the sensing switch request ACK or the sensing switch request NACK, a sensing report for the first wireless device.

25. The apparatus of claim 15, wherein the sensing switch request message is received if the first sensing RSRP is less than the first threshold.

26. The apparatus of claim 15, wherein the sensing switch request ACK is transmitted if the second sensing RSRP is greater than the second threshold, and the sensing switch request NACK is transmitted if the second sensing RSRP is less than or equal to the second threshold.

27. The apparatus of claim 15, wherein the sensing switch request message includes at least one of: the position of the target object, a speed of the target object, a Doppler frequency profile of the target object, a micro-Doppler signature of the target object, or a sensing signal configuration.

28. The apparatus of claim 15, wherein the target object is at least one of: an unmanned aerial vehicle (UAV), a user equipment (UE), a base station, a first object with a communication function, or a second object without the communication function.

29. A method of wireless communication at a first wireless device, comprising:
detecting whether a first sensing reference signal received power (RSRP) is less than a first threshold, the first sensing RSRP being associated with at least one sensing signal;
identifying, upon detecting whether the first sensing RSRP is less than the first threshold, at least one second wireless device of a set of candidate second wireless devices, wherein the at least one second wireless device is identified based on a position of a target object;
transmitting a sensing switch request message for the at least one second wireless device; and
receiving, based on the sensing switch request message, a sensing switch request acknowledgement (ACK) or a sensing switch request negative ACK (NACK) from the at least one second wireless device.

30. A method of wireless communication at a second wireless device, comprising:
receiving a sensing switch request message from a first wireless device, the sensing switch request message being based on whether a first sensing reference signal received power (RSRP) is less than a first threshold;
selecting a target sensing beam from a set of candidate target sensing beams based on a position of a target object associated with the second wireless device;
detecting whether a second sensing RSRP is greater than a second threshold, wherein the second sensing RSRP is associated with at least one sensing signal; and
transmitting, upon detecting whether the second sensing RSRP is greater than the second threshold, a sensing switch request acknowledgement (ACK) or a sensing switch request negative ACK (NACK) for the first wireless device.
